(19) United States
(12) Patent Application Publication
(10) Pub. No.: US 2024/0006610 A1
(43) Pub. Date: Jan. 4, 2024

(54) MIXED SiO4 AND PO4 SYSTEM FOR FABRICATING HIGH-CAPACITY CATHODES

(71) Applicant: Mitra Future Technologies, Inc., Mountain View, CA (US)

(72) Inventors: Peter Csernica, Daly City, CA (US); Russell Clayton Pratt, San Mateo, CA (US); Chirranjeevi Gopal, San Francisco, CA (US); William Chueh, Menlo Park, CA (US); Jordan Lampert, Cambria, CA (US); Liu Luo, San Jose, CA (US); Andrea Bowring, Mountain View, CA (US)

(21) Appl. No.: 18/344,749

(22) Filed: Jun. 29, 2023

Related U.S. Application Data
(60) Provisional application No. 63/357,393, filed on Jun. 30, 2022.

(51) Int. Cl. H01M 4/58; H01M 10/42

(52) U.S. Cl. CPC H01M 4/5825; H01M 10/4285; H01M 2004/028

(57) ABSTRACT

The present technology discloses lithium metal polyanion (LMX) cathode compounds which contain a mixture of SiO₄ and PO₄ anions. Compounds based on silicate SiO₄ anions can exhibit significantly higher gravimetric capacities than conventional lithium iron phosphate (LFP) materials. The present technology offers electrochemical advantages of the LMX compounds over compounds fabricated with only SiO₄ anions. Machine learning can be used to provide the synthesis conditions and the stoichiometry of LMX compounds to maximize the gravimetric energy density of a battery cell.

### CROSS-REFERENCE TO RELATED PATENT APPLICATION

This patent application claims the benefit under 35 U.S.C. § 119(e) of U.S. Patent Application Ser. No. 63/357,393, entitled “MIXED SiO₄ AND PO₄ SYSTEM FOR FABRICATING HIGH-CAPACITY CATHODES,” filed on Jun. 30, 2022, which is incorporated herein by reference in its entirety.

### TECHNICAL FIELD

The subject technology relates to generating increased gravimetric energy density (GED) for lithium metal polyanion batteries, and more specifically, relates to increasing exchangeable Li-ion content and/or average discharge voltage from a combination of experiments and a machine-learning model.

### BACKGROUND

Lithium-ion batteries have been widely adopted as the most promising portable energy source in electronic devices because of their high working voltage, high energy density, and good cyclic performance. Lithium-ion batteries are used in electric vehicles and hybrid electric vehicles. In these lithium-ion batteries, olivine-type cathode materials such as LiMPO₄ (M=Fe and Mn) have attracted significant interest, especially due to their low cost and high intrinsic safety. However, these materials have limited energy density compared to other materials.

Lithium-Metal-Phosphates (LMP) where M=Mn have been extensively studied and described in the literature. LMP has been used as cathode materials for Li-ion batteries. This LMP cathode material has a nominal discharge voltage of 4.1 V, thus having a higher gravimetric energy density (GED) than lithium iron phosphate (LFP) by nominally 20%. However, LMP suffers from poor kinetics and lithium (Li) utilization because the orientation of the two-phase interface blocks the channel for Li-ion (Li+) diffusion.

Conventional LFP has limited gravimetric energy density (GED) due to its relatively low discharge voltage (nominally 3.4 V) and a moderate capacity (e.g., theoretical gravimetric capacity is 170 mAh/g while practical capacity ranges from 140 to 165 mAh/g).

There has been extensive work on LiMPO₄ or Li₂MSiO₄ compounds, where M represents a transition metal or two or more transition metals and PO₄ or SiO₄ is used as the only anion. Very limited studies have been conducted on a mixture of PO₄ anions and SiO₄ anions. For example, U.S. Pat. No. 5,910,382A discloses Li-ion cathodes including a mixture of PO₄ anions and SiO₄ anions. U.S. Pat. No. 6,136,472 also discloses a mixed Li-ion composition with SiO₄ and PO₄ anions in the sodium superionic conductor (NASICON) structure and includes the composition LiₐM′_{(2-b)}M″_{b}Si_{c}P_{3-c}O₁₂. A mixture of PO₄ and SiO₄ anions has also been used as solid electrolytes for Na-ion batteries. The most well-known example crystallizes in the NASICON structure with the chemical formula Na₃Zr₂(PO₄)(SiO₄)₂.

Multi-modal distribution is a commonly employed technique to achieve higher green densities in ceramics. One common application is 3D printing. In binder jetting, the ability to achieve high green density is limited by the layer thickness of the powder, which may be overcome by mixing the powders including different particle sizes or different distributions of the particle sizes.

Batteries are an essential part of many devices from power tools to home power systems to electric and hybrid cars, among many other applications. Lithium iron phosphate (LFP) has been developed for power applications, such as power tools, starter batteries, and hybrid electric vehicles, among others. LFP's use in battery electronic vehicles (BEVs) is limited because of its low energy density. Batteries are a key technological pillar upon which many other technologies are built. Given the wide range of applications in which batteries are used, there is a similarly wide range of design requirements to develop battery cathode materials suitable for their applications. Unfortunately, the development of a new battery can be a time-consuming and expensive process.

Machine learning has shown promising results in a variety of applications. In the field of materials science, machine learning is used to develop new materials, optimize existing materials, and predict the properties of materials. One area of interest in the field of materials science is the synthesis of cathode materials for lithium-ion batteries. Lithium-ion batteries are used in many applications, including portable electronics, electric vehicles, and energy storage systems. The performance of these batteries is partially dependent on the cathode material used.

Lithium iron phosphate (LFP), nickel-cobalt-aluminum oxide (NCA), and nickel-cobalt-manganese oxide (NMC) are commonly used cathode materials in lithium-ion batteries. Synthesis of these cathode materials is a complex process involving various precursors and synthesis processing conditions. Modifying the precursors and synthesis processing conditions allow for the optimization of the properties of cathode materials. However, when optimizing the properties of cathode materials, it is challenging, expensive, and time-consuming to select precursors and the ratios of precursors and to control synthesis processing conditions.

Carbon coating is a commonly employed technique for improving the conductivity of cathode active materials in lithium-ion batteries. Carbon coating can improve the electrical conductivity of cathode active materials without changing other intrinsic properties. Uniform coating of carbon on LFP helps avoid charge congregation and unpreferable chemical reactions. Carbon coatings on cathode active materials or compounds, such as LFP, LMP, or lithium metal polyanion (LMX) compounds, may affect the cycling performance of the battery cells which contain carbon coated cathode powders.

It is desirable to have cathode materials with improved properties at reduced costs. However, development cycles for cathode materials with improved properties are very long. Therefore, there remains a need to develop methods to accelerate cathode material synthesis and battery cell production.

### BRIEF SUMMARY

The present technology utilizes machine learning to provide the synthesis conditions and stoichiometry of a lithium metal polyanion (LMX) compound represented in Formula (I) and Formula (II) to improve the cycling performance of a battery cell.

In one aspect, a powder containing a lithium metal polyanion (LMX) compound, where X represents a mixture of SiO₄ or PO₄, is given by Formula (I):

Li₁₊ₓM(PO₄)₁₋ₓ(SiO₄)ₓ Formula (I)

wherein 0.001<x<0.25 or 0.75<x<1, and wherein M is one or more metal cations summing to a stoichiometry of 1.

In another aspect, a powder containing a lithium metal polyanion (LMX) compound is given by Formula (II):

LiₐM_{b}(SiO₄)_{1-c}(PO₄)_{c} Formula (II)

wherein a+b<3.0, 1.33≤a≤2.25, 0.75≤b≤1.33, 0.001<c<0.25, and wherein M represents one or more metal cations.

In some variations, M is one or more elements selected from a group of elements consisting of Mn, Fe, V, Co, Ni, Mg, Zn, Ca, Na, Al, Cr, or Cu.

In some variations, M in Formula (I) is Mn, x=0.9, and the compound is represented by Li_{1.9}Mn(SiO₄)_{0.9}(PO₄)_{0.1}.

In some variations, M in Formula (I) is Fe and Mn, and the compound is represented by Li_{1.9}Mn_{0.9}Fe_{0.1}(SiO₄)_{0.9}(PO₄)_{0.1}.

In some variations, at least one process variable or at least one stoichiometry variable required to produce the compound represented in Formula (I) may be provided by a machine learning algorithm.

In another aspect, a method is provided for designing the LMX compound. The method may include optimizing the composition of the LMX compound to achieve high gravimetric energy density (GED) using a machine learning (ML) algorithm-assisted design combined with an experimental approach.

In some variations, the method may further include synthesizing the compound in Formula (I) or Formula (II) to form the powder. The method may also include evaluating the powder and the battery cell for electrochemical performance. The method may also include using the electrochemical performance and the powder information to train a Machine Learning (ML) model. The method may also include fitting a Gaussian process model using the energy density of the battery cell as output, subject to the constraints of powder level metrics falling within the set specs. The method may also include using the acquisition function to determine N variations to evaluate in the next iteration, which is likely to maximize the energy density. The method may also include synthesizing the N variations. The method may also include evaluating the powder and the electrochemical performance of the battery cell, repeating the experiments, and training the ML model until the difference in successive iterations falls below a threshold.

In some variations, a cathode active material may include the LMX powder.

In some variations, a cathode may include the cathode active material.

In some variations, a battery cell may include the cathode, a separator, and an anode, wherein the battery cell comprises a gravimetric capacity exceeding 170 mAh/g when normalized to the cathode active material mass.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a top-down view of a battery cell according to some aspects of the disclosed technology;

FIG. 2 illustrates a side view of a set of layers for a battery cell according to some aspects of the disclosed technology;

FIG. 3 illustrates phase purity varying with compound compositions for various ratios of SiO₄ and PO₄ in LMX compounds according to some aspects of the disclosed technology;

FIG. 4 is a workflow illustrating the steps for cathode synthesis and qualification at both powder and cell levels according to some aspects of the disclosed technology;

FIG. 5 illustrates XRD results of Li₂₋ₓM(SiO₄)₁₋ₓ(PO₄)ₓ compounds with x=0, 0.1, 0.15, and 0.2 according to some aspects of the disclosed technology;

FIG. 6 illustrates XRD results of Li₂M_{1-0.5x}(SiO₄)₁₋ₓ(PO₄)ₓ compounds with x=0, 0.1, 0.2, and 0.3 according to some aspects of the disclosed technology;

FIG. 7 illustrates XRD results of Li₂₊ₓM₁₋ₓ(SiO₄)₁₋ₓ(PO₄)ₓ compounds with x=0, 0.1, 0.2, and 0.3, M=Mn according to some aspects of the disclosed technology;

FIG. 8 shows the XRD results of Li_{1.8}Mn(SiO₄)₁₋ₓ(PO₄)_{0.2} calcined at three different temperatures, 600° C., 700° C., and 800° C. according to some aspects of the disclosed technology;

FIG. 9 shows the XRD results of Li₂Mn_{0.9}(SiO₄)₁₋ₓ(PO₄)_{0.2} calcined at three different temperatures, 600° C., 700° C., and 800° C. according to some aspects of the disclosed technology;

FIG. 10 shows the XRD results of Li_{2.2}Mn_{0.8}(SiO₄)₁₋ₓ(PO₄)_{0.2} calcined at three different temperatures, 600° C., 700° C., and 800° C. according to some aspects of the disclosed technology;

FIG. 11 shows comparisons of specific discharge capacity versus aging cycles for Li_{1.9}Mn(SiO₄)_{0.9}(PO₄)_{0.1} compound and Li_{2.1}Mn_{0.9}(SiO₄)_{0.9}(PO₄)_{0.1} compound according to some aspects of the disclosed technology;

FIG. 12 shows comparisons of specific discharge capacity versus aging cycles for Li₂Mn_{0.9}(SiO₄)_{0.8}(PO₄)_{0.2} compound and Li_{2.2}Mn_{0.8}(SiO₄)_{0.8}(PO₄)_{0.2} compound according to some aspects of the disclosed technology;

FIG. 13 shows discharge capacity versus the number of cycles at 25° C. for coin cells with various cathode compounds including baseline compound Li₂MnSiO₄ and compound Li_{1.9}Mn(SiO₄)_{0.9}(PO₄)_{0.1} according to some aspects of the disclosed technology;

FIG. 14 shows discharge capacity retention versus the number of cycles at 25° C. for coin cells with various cathode compounds including baseline compound Li₂MnSiO₄ and compound Li_{1.9}Mn(SiO₄)_{0.9}(PO₄)_{0.1} according to some aspects of the disclosed technology;

FIG. 15 shows average discharge voltage versus the number of cycles at 25° C. for coin cells with various cathode compounds including baseline compound Li₂MnSiO₄ and compound Li_{1.9}Mn(SiO₄)_{0.9}(PO₄)_{0.1} according to some aspects of the disclosed technology;

FIG. 16 shows discharge energy versus the number of cycles at 25° C. for coin cells with various cathode compounds including baseline compound Li₂MnSiO₄ and compound Li_{1.9}M(SiO₄)_{0.9}(PO₄)_{0.1} according to some aspects of the disclosed technology;

FIG. 17 shows discharge capacity versus the number of cycles at 45° C. for coin cells with various cathode compounds including baseline compound Li₂MnSiO₄ and compound Li_{1.9}Mn(SiO₄)_{0.9}(PO₄)_{0.1} according to some aspects of the disclosed technology;

FIG. 18 shows discharge capacity retention versus the number of cycles at 45° C. for coin cells with various cathode compounds including baseline compound Li₂MnSiO₄ and compound Li_{1.9}Mn(SiO₄)_{0.9}(PO₄)_{0.1} according to some aspects of the disclosed technology;

FIG. 19 shows average discharge voltage versus the number of cycles at 45° C. for coin cells with various cathode compounds including baseline compound Li₂MnSiO₄ and compound Li_{1.9}Mn(SiO₄)_{0.9}(PO₄)_{0.1} according to some aspects of the disclosed technology;

FIG. 20 shows discharge energy versus the number of cycles at 45° C. for coin cells with various cathode compounds including baseline compound Li₂MnSiO₄ and compound Li_{1.9}Mn(SiO₄)_{0.9}(PO₄)_{0.1} according to some aspects of the disclosed technology;

FIG. 21 illustrates an example of a deep learning neural network that can be used to implement a perception module and/or one or more validation modules, according to some aspects of the disclosed technology;

FIG. 22 illustrates an example processor-based system with which some aspects of the disclosed technology can be implemented; and

FIG. 23 illustrates XRD results of compounds LiFePO₄ and Li_{1.1}Mn_{0.1}Fe_{0.9}(SiO₄)_{0.1}(PO₄)_{0.9} according to some aspects of the disclosed technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details to provide a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

The disclosures of these patents, patent applications, and publications in their entireties are hereby incorporated by reference into this application to more fully describe the state of the art as known to those skilled therein as of the date of the invention described and claimed herein. The instant disclosure will govern in the instance that there is any inconsistency between the patents, patent applications, and publications and this disclosure.

Unless defined otherwise, all technical and scientific terms used herein have the same meaning as commonly understood by one of ordinary skill in the art to which this disclosure belongs. The initial definition provided for a group or term herein applies to that group or term throughout the present specification individually or as part of another group unless otherwise indicated.

To explain the invention well-known features of Lithium-ion battery technology known to those skilled in the art have been omitted or simplified in order not to obscure the basic principles of the invention. Parts of the following description will be presented using terminology commonly employed by those skilled in the art.

### i. Definitions

“Capacity” of a battery or battery cell is a measure of the charge stored by the battery and is determined by the active materials contained in the battery. The capacity represents the maximum amount of charge that can be extracted from the battery under certain specified conditions. The battery has a discharge current in amperes that can be delivered over time. The capacity of the battery is given in ampere-hours (Ah).

“Gravimetric capacity” is the capacity per unit mass (mAh/g). Gravimetric capacity is also referred to as specific capacity.

“Gravimetric energy density,” or specific energy, of a battery or battery cell is a measure of how much energy the battery contains in comparison to its weight and is typically expressed in Watt-hours/kilogram (W-hr/kg).

“Volumetric energy density” of a battery or battery cell is a measure of how much energy the battery contains in comparison to its volume and is typically expressed in Watt-hours/liter (W-hr/liters).

“Discharge energy” is the product of discharge capacity multiplying average discharge voltage.

“Discharge capacity retention” is the discharge capacity after a number of cycles normalized against the discharge capacity of the first cycle.

“Tap density” is a material property for a powder. The tap density of a powder is determined after defined tapping steps of the powder bed. More specifically, tap density considers pores and voids between particles, which are not based on a loose powder bed but a bed after a defined number of tapping steps. The tap density of a powder is a measure of the mass of the powder to the volume occupied by the powder after the defined tapping steps of the powder bed. The tap density is different from the bulk density of a powder, which can be determined if a powder is loosely poured into a measuring cylinder. The bulk density considers the pores and voids of a loose powder bed.

An oxidation-reduction (redox) reaction is a type of chemical reaction that involves a transfer of electrons between two species. An oxidation-reduction reaction is any chemical reaction in which the oxidation number of a molecule, atom, or ion changes by gaining or losing an electron.

### ii. Overview

The present technology provides lithium metal polyanion (LMX) compounds involving a mixture of PO₄ and SiO₄ anions which may have gravimetric capacities exceeding 170 mAh/g. In this disclosure, the SiO₄ anion (SiO₄⁴⁻) is mixed with the PO₄ anion (PO₄³⁻) in a single material. The addition of SiO₄ in place of PO₄ is charge compensated by adding additional exchangeable Li to the structure, thereby increasing the capacity and energy density of the cathode material. Meanwhile, the PO₄ units may help to stabilize the structure over cycling in comparison to materials that solely include the SiO₄⁴⁻ anion (i.e., Li₂MSiO₄ materials).

The lithium (Li) content, nature, anion composition (e.g., SiO₄/PO₄), amount of doping, and synthesis conditions can be optimized using a machine learning (ML) assisted design combined with an experiment, which is called active learning. The resulting LMX compounds from the ML-assisted design can have higher GED than Li₂MSiO₄ compounds by increasing their capacity and/or average discharge voltage.

One class of cathodes, orthosilicates of type Li₂MSiO₄, where M represents one or more transition metals, generally have lower redox voltages than pure phosphate systems for the same redox couple but allow extraction of up to two Li per formula unit as M changes its oxidation state from 2+ to 3+ to 4+, practically doubling the capacity of the material. However, the silicate systems suffer from poor cycle life as the crystal structure undergoes a variety of phase transitions as Li is intercalated in and out of the system.

The present technology addresses the issue of poor cycle life of Li₂MSiO₄ materials by involving the partial substitution of PO₄ for SiO₄, tapping into the higher theoretical energy density of the silicates and the stabilizing effect of phosphate polyanions. The present technology provides the compound formula with improved cycling performance over Li₂MSiO₄ materials.

The present technology also provides compounds having a structure with site-vacancies or cation vacancies (Li+M is less than 3) for the structural stability and improved cycling performance over some known compounds having a structure without site-vacancies or cation vacancies (Li+M equal to 3). The disclosed compounds can have a single phase and better performance than the known compounds.

The present technology involves fabrication of Li-ion cathode materials which include both PO₄ and SiO₄ tetrahedral units in their anion framework. The ratio of metals other than Li to XO₄ tetrahedra (X=P, Si) is between 0.75 and 1.33.

The resulting cathode compounds can be used in battery cells which can be used for various purposes, such as electric vehicles. The resulting cathode compounds may result in a higher capacity and gravimetric energy density of the battery or battery cell than LiMPO₄ cathode compounds due to the additional Li in the structure. A typical Li-ion phosphate material utilizing the 3− phosphate anion (PO₄³⁻) and a transition metal (M) with a 2+ charge has a formula of LiMPO₄. However, the silicate anion (SiO₄⁴⁻) has a 4− charge, which allows an extra Li to be introduced into the compound with an end-member composition of Li₂MSiO₄.

### iii. Battery Cells

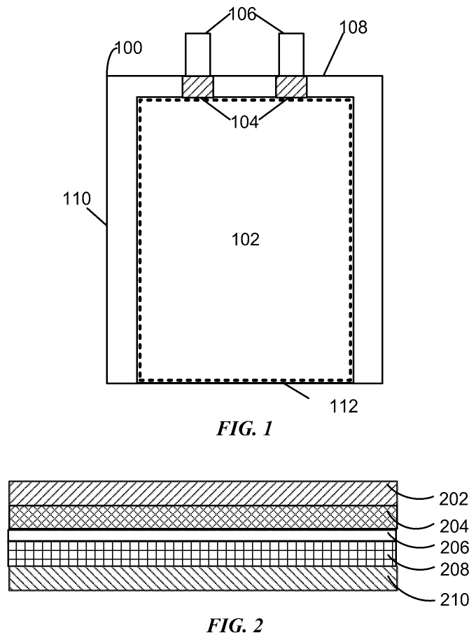

FIG. 1 illustrates a top-down view of a battery cell 100 according to some aspects of the disclosed technology. The battery cell 100 may correspond to a lithium-ion battery cell that is used to power a device used in a consumer, medical, aerospace, defense, and/or transportation application.

The battery cell 100 includes a stack 102 containing a number of layers that include a cathode with a cathode active material, a separator, and an anode with an anode active material.

More specifically, stack 102 may include one strip of cathode active material (e.g., aluminum foil coated with a lithium compound) and one strip of anode active material (e.g., copper foil coated with carbon). Stack 102 also includes one strip of separator material (e.g., conducting polymer electrolyte) disposed between the one strip of cathode active material and the one strip of anode active material. The cathode, anode, and separator layers may be left flat in a planar configuration.

Enclosures can include, without limitations, pouches, such as flexible pouches, rigid containers, and the like. Returning to FIG. 1, during assembly of the battery cell 100, stack 102 is enclosed in an enclosure. Stack 102 may be in a planar or wound configuration, although other configurations are possible.

Stack 102 can also include a set of conductive tabs 106 coupled to the cathode and the anode. The conductive tabs 106 may extend through seals in the enclosure (for example, formed using sealing tape 104) to provide terminals for the battery cell 100. The conductive tabs 106 may then be used to electrically couple the battery cell 100 with one or more other battery cells to form a battery pack. The battery cell may be used for battery electric vehicles. In some variations, the battery cell 100 may be a coin cell.

Batteries can be combined in a battery pack in any configuration. For example, the battery pack may be formed by coupling the battery cells in a series, parallel, or series-and-parallel configuration. Such coupled cells may be enclosed in a hard case to complete the battery pack or may be embedded within an enclosure of a portable electronic device, such as a laptop computer, tablet computer, mobile phone, personal digital assistant (PDA), digital camera, and/or portable media player.

FIG. 2 presents a side view of a set of layers for a battery cell according to some aspects of the disclosed technology. The set of layers may include a cathode current collector 202, a cathode active material 204, a separator 206, an anode active material 208, and an anode current collector 210. The cathode current collector 202 and the cathode active material 204 may form a cathode for the battery cell, and the anode current collector 210 and the anode active material 208 may form an anode for the battery cell. To create the battery cell, the set of layers may be stacked in a planar configuration or stacked and then wrapped into a wound configuration.

As mentioned above, the cathode current collector 202 may be aluminum foil, the cathode active material 204 may be a lithium compound, the anode current collector 210 may be a copper foil, the anode active material 208 may be carbon, and the separator 206 may include a conducting polymer electrolyte.

### iv. Lithium Metal Polyanion Compounds

In one example, the present technology provides a compound that is synthesized with the Formula (I) as follows:

Li₁₊ₓM(PO₄)₁₋ₓ(SiO₄)ₓ Formula (I)

where 0.001<x<0.25 or 0.75<x<1 and M can be a combination of one or more metals summing to a stoichiometry of 1. The Li can be extracted from this compound if the metal participates in multiple-electron redox during charging. When 0.001<x<0.25 or 0.75<x<1, the compound may have a single phase without significant impurities. Otherwise, the compound may have significant impurities.

Impurities, such as Mn₂SiO₄, MnO, or Li₃PO₄ may be generated. Phase separation occurs when the impurity appears with a considerable amount, such about 10% or more. The presence of impurities and the amounts of impurities may vary with the formulation of compounds. The presence of impurities and the amounts of impurities may also vary with the calcination temperatures.

In some variations, 0.75<x<1. In some variations, 0.80<x<1. In some variations, 0.85<x<1. In some variations, 0.9<x<1. In some variations, 0.95<x<1.

In some variations, 0.001<x<0.25. In some variations, 0.001<x<0.2. In some variations, 0.001<x<0.15. In some variations, 0.001<x<0.10. In some variations, 0.001<x<0.05.

In another example, the present technology provides a compound that is synthesized with the Formula (II) as follows:

LiₐM_{b}(SiO₄)_{1-c}(PO₄)_{c}, Formula (II)

where a+b<3.0, 1.33 K a K 2.25, 0.75≤b≤1.33, 0.001<c<0.25, and where M represents one or more metal cations. M is one or more elements selected from a group of elements consisting of Mn, Fe, V, Co, Ni, Mg, Zn, Ca, Na, Al, Cr, or Cu. In some variations, when M is Mn, a=1.9, b=1, c=0.1, the compound in Formula (II) becomes Li_{1.9}Mn(SiO₄)_{0.9}(PO₄)_{0.1}.

The subscripts a, b, and c in Formula (II) represent how many atoms of the compound are present per formula unit. When the subscript is 1 (i.e., one atom), no value is listed. For example, Li₂MnSiO₄ contains two lithium atoms, one manganese atom, one silicon atom, and four oxygen atoms per formula unit. In this case, there are eight total atoms per formula unit. The atomic percentage of lithium in compound Li₂MnSiO₄ is 2/8=25%.

The subscripts a, b, c may be integers or non-integers including decimal values. For example, Li_{1.5}MnSiO₄ contains 1.5 lithium atoms per formula unit. In this case, there are 7.5 total atoms per formula unit, and so the atomic percentage of lithium is 1.5/7.5=0.2, or 20%.

In some variations, 1.33≤a≤2.25. In some variations, 1.4≤a≤2.1. In some variations, 1.5≤a≤2.1. In some variations, 1.6≤a≤2.1. In some variations, 1.7≤a≤2.1. In some variations, 1.8≤a≤2.1. In some variations, 1.9≤a≤2.1. In some variations, 1.4≤a≤2.0. In some variations, 1.5≤a≤2.0. In some variations, 1.6≤a≤2.0. In some variations, 1.7≤a≤2.0. In some variations, 1.8≤a≤2.0. In some variations, 1.9≤a≤2.0.

In some variations, 0.75≤b≤1.33. In some variations, 0.8≤b≤1.2. In some variations, 0.85≤b≤1.2. In some variations, 0.9≤b≤1.2. In some variations, 0.95≤b≤1.2. In some variations, 0.75≤b≤1.1. In some variations, 0.8≤b≤1.1. In some variations, 0.85≤b≤1.1. In some variations, 0.9≤b≤1.1. In some variations, 0.95≤b≤1.1. In some variations, 0.99≤b≤1.1.

In some variations, 0.001<c<0.25. In some variations, 0.001<c<0.20. In some variations, 0.001<c<0.15. In some variations, 0.001<c<0.10. In some variations, 0.001<c<0.05.

The SiO₄ anion carries a 4− charge while the PO₄ anion carries a 3− charge. Therefore, when SiO₄ units are partially replaced with PO₄ units, the amount of M or Li may change in order to balance the charge change due to the partial replacement of the SiO₄ units with the PO₄ units.

When the SiO₄ of Li₂MnSiO₄ is partially changed to PO₄, one way to balance the charge may include removing lithium ions. In Formula (II), when a=2−x, b=1, c=x, the compound is represented by formula (III)

Li₂₋ₓM(SiO₄)₁₋ₓ(PO₄)ₓ Formula (III)

where 0.001<x<0.25 and M is one or more elements selected from a group of elements consisting of Mn, Fe, V, Co, Ni, Mg, Zn, Ca, Na, Al, Cr, or Cu. The compound Li₂₋ₓM(SiO₄)₁₋ₓ(PO₄)ₓ has a constant transition metal (M) content, but is also Li deficient since Li is 2−x, while Li+M<3.

In some variations, 0.001<x<0.25 in Formula (III). In some variations, 0.001<x<0.20 in Formula (III). In some variations, 0.001<x<0.15 in Formula (III). In some variations, 0.001<x<0.10 in Formula (III). In some variations, 0.001<x<0.05 in Formula (III).

Another way to balance the charge when substituting SiO₄ units for PO₄ units may include removing metal cations. In Formula (II), when a=2, b=1−0.5x, c=x, the compound is represented by formula (IV):

Li₂M_{1-0.5x}(SiO₄)₁₋ₓ(PO₄)ₓ Formula (IV)

where 0.001<x<0.25, M is one or more selected from a group of elements consisting of Mn, Fe, V, Co, Ni, Mg, Zn, Ca, Na, Al, Cr, or Cu. The compound Li₂M_{1-0.5x}(SiO₄)₁₋ₓ(PO₄)ₓ has a constant Li content, but varied M while Li+M<3.

In some variations, 0.001<x<0.25 in Formula (IV). In some variations, 0.001<x<0.20 in Formula (IV). In some variations, 0.001<x<0.15 in Formula (IV). In some variations, 0.001<x<0.10 in Formula (IV). In some variations, 0.001<x<0.05 in Formula (IV).

Some references, including (1) “Synthesis and structural stability of Li_{2.1}Mn_{0.9}[PO₄]_{0.1}[SiO₄]_{0.9}/C mixed polyanion cathode material for Li-ion battery,” by Peng-Yuan Zhai, Shi-Xi Zhao, Hong-Mei Cheng, Jian-Wei Zhao, Ce-Wen Nan, on Electrochimica Acta 153 (2015) 217-224; (2) “Li₂₊ₓMn₁₋ₓPₓSi₁₋ₓO₄/C as novel cathode materials for lithiumion batteries” by S. Zhang, C. Deng, H. Gao, F. L. Meng, M. Zhang, on Electrochimica Acta 107 (2013) 406-412, disclose a compound represented by Formula (V):

Li₂₊ₓM₁₋ₓ(SiO₄)₁₋ₓ(PO₄)ₓ Formula (V)

where Li+M=3. Cycling tests for cells including cathodes from Formulas (III), (IV), and (V) demonstrate that compounds having structures with site-vacancies (i.e., Li+M is less than 3) have improved capacity and structural stability, resulting in improved cycling performance.

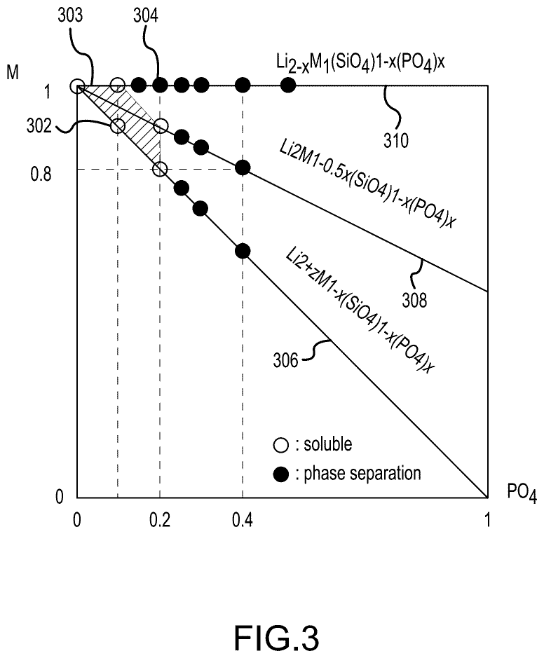

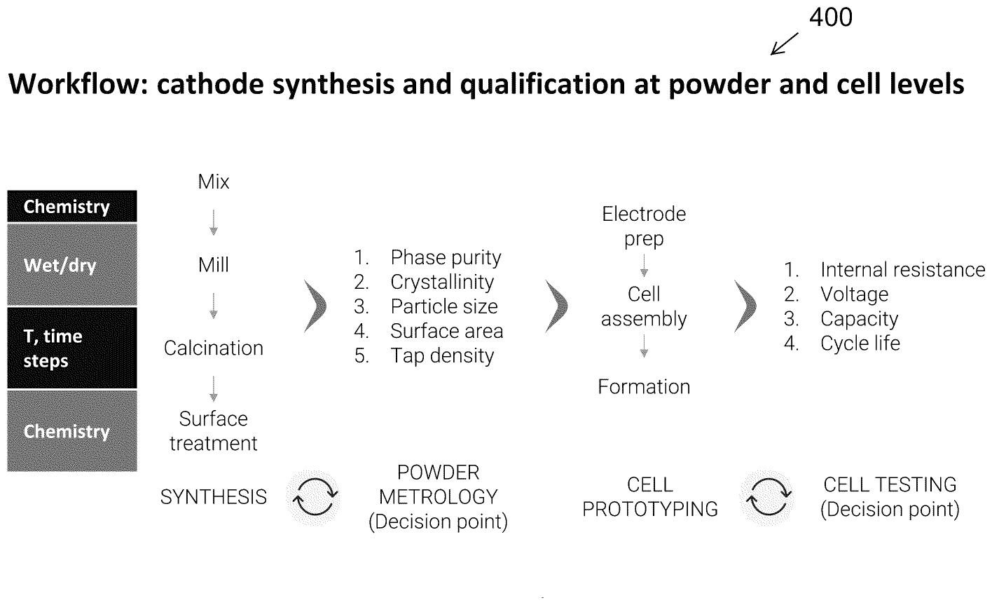

FIG. 3 illustrates phase purity varying with compound compositions for various ratios of SiO₄ and PO₄ in LMX compounds according to some aspects of the disclosed technology. A horizontal axis represents the ratio of PO₄ versus SiO₄. To the right end on the horizontal axis, PO₄ is 1, while SiO₄ is 0. To the left end on the horizontal axis, SiO₄ is 1, while PO₄ is 0. A vertical axis represents the content value from 0 to 1 for metal cation M. Line 310 and line 308 in FIG. 3 represent Li₂₋ₓM(SiO₄)₁₋ₓ(PO₄)ₓ in Formula (III) and Li₂M_{1-0.5x}(SiO₄)₁₋ₓ(PO₄)ₓ in Formula (IV), respectively. Line 306 represents known compounds Li₂₊ₓM₁₋ₓ(SiO₄)₁₋ₓ(PO₄)ₓ in Formula (V), which is used as a reference. The reference compound represented by line 306 has Li greater than 2 and a sum of cations (Li+M) equal to 3, and thus has no cation vacancies.

In contrast, the disclosed two compounds represented by the other two lines 308 and 310 have a sum of cations (Li+M) less than 3, and thus have cation vacancies. As illustrated, the disclosed compounds with Li+M<3 yield better cell performance than the known compounds with Li+M=3.

As shown in FIG. 3, grey dots 302 forms a contour of a shadowed region 303 near an upper left corner where x is from 0 to 0.2 on the horizonal axis, PO₄. Grey dots 302 indicate the compounds have a single phase without a significant amount of impurity emerging during synthesis of the compound. Black dots 304 outside the region 303 indicate the compounds have impurities or different levels of phase separation, e.g., considerable amounts of impurities emerge during synthesis of the compound.

In some variations, impurities may be less than 25 wt %. In some variations, impurities may be less than 20 wt %. In some variations, impurities may be less than 15 wt %. In some variations, impurities may be less than 10 wt %. In some variations, impurities may be less than 5 wt %.

### v. Machine Learning Assisted Optimization of LMX Cathode Active Material

There are thousands to tens of thousands of possible variations to test to achieve an optimal cathode and each variation is resource intensive, expensive, and time consuming to synthesize and test. For example, such variables to be adjusted in the design space include at least: (1) The amount of PO₄ or SiO₄ in the chemical composition (2) The nature and stoichiometry of the transition metal(s) used (M), (3) Type of synthesis route (e.g. Solid-state, hydrothermal, microwave, among others), (4) Synthesis conditions (e.g. Maximum temperature, time at maximum temperature, solvent, among others), and (5) Conductive coating, if any, on the material surface (e.g. carbon source for carbon coating).

There is no analytical relation between the variables and the metrics of interest (such as electrochemical performance of the cathode, particle size, tap density, phase purity etc.). The goal is to determine a probable result as measured by the metrics of interest for a set of parameters for the variables.

Active learning refers to a class of machine learning models that guide efficient and parsimonious data collection to build a model that maps from inputs for the variables (design variables) to outputs as quantified by the metrics of interest. A specific implementation involves Bayesian optimization to trade-off exploration and exploitation strategies. The two components of a Bayesian optimization are 1) model function and 2) acquisition function.

For the model function, Gaussian Processes will be used because of their probabilistic basis and ability to encode physically-grounded kernels for the covariance function.

The goal of Bayesian optimization is to use a set of observations and suggest where to evaluate the experiment next. The acquisition function is typically an inexpensive function that can be evaluated at a given point that is commensurate with how desirable evaluating f at x is expected to be for the minimization problem. The acquisition function can be optimized to select the location of the next observation. It can also be interpreted as a loss function in the context of optimization problems. Typical choices of acquisition functions include the probability of improvement, expected improvement, upper confidence bound, among others. Certain acquisition functions, such as expected improvements, are better for research settings, where the goal of experimentation is to “explore” a design space, while “upper confidence bound” acquisition function is better suited for a global maximization (or minimization) as in a more development setting.

The acquisition function can be one of upper confidence bound, expected improvement, or information gain can be used. There is a trade-off between exploration and exploitation based on the intent of the experimental campaign (research vs development). Further, the optimization can be performed in a batch setting, implying that at each iteration, multiple data points can be collected in parallel, subject to constraints of available resources.

For example, a workflow for an experimental campaign to increase gravimetric energy density can be as follows:
Step 1: Synthesize N variations from the variables in the design space addressed above, and evaluate powder specs and coin cell electrochemical data. A variation is defined as a vector of values for the variables in the design space above. This serves as seed data to train the model.
Step 2: Fit a Gaussian Process model using coin cell energy density as the output, subject to the constraints of set specifications that the powder level metrics should fall within.
Step 3: Using the acquisition function, determine N variations [N can be varied] to evaluate in the next iteration, which is likely to or predicted to increase the energy density.
Step 4: Synthesize the N variations from step 3 and evaluate powder specs and coin cell electrochemical data.
Step 5: Repeat steps 2-4 until either the experimental budget is exhausted, the difference in successive iterations falls below a threshold, or an iteration satisfies set specifications for the target gravimetric energy density (GED).

Cathode development involves trade-offs. The algorithm can provide Pareto-optimal choices of design variables that increase gravimetric energy density without severely compromising rate capability, resistance, tap density, and other quantities. The algorithm can also work with noisy data and categorical variables.

The cathode developments are used to study a particular excess Li range to achieve the target gravimetric energy density (GED) by combining experiments with machine learning.

When excess Li is used to increase GED, other properties may become worse or may be compromised. Machine learning can help discover the appropriate tradeoffs. For example, machine learning predictions can help discover how life cycle, capacity, voltage, energy retention, stability, among others, will be affected. The optimization is multi-objective including increasing GED and trying not to compromise transport properties (conductivity, surface reaction kinetics, Li+ diffusion rate, etc.), and cycle life, among other factors. The optimization will be Pareto-optimal and discover the trade-offs. All the other metrics can be measured as well and be used for informing experiments. For example, to maximize GED, constraints can include keeping the voltage less than 4.3 V, utilizing elements that are still abundant are used (e.g., to reduce material cost), while also having a goal of getting identical or improved transport properties.

Machine learning can help reduce the number of experiments to run in arriving at the target GED. There will be efficiency gain in terms of the number of experiments to run to achieve a set trade-off. Each set of experiments will be informed by the prior experiments and data. Compared to the traditional design of experiments, where the design is static (i.e., experiments to run are preset), Bayesian optimization and/or active learning approaches dynamically decide data collection and build a model of the response surface with every incremental data collection. This allows one to use the most updated information to decide the course of further experiments.

### vi. Workflow for Cell Development

FIG. 4 is a workflow illustrating the steps for cathode synthesis and qualification at powder and cell levels according to an embodiment of the disclosure. As an example, workflow 400 is provided for forming a battery cell. Workflow or process 400 includes (1) synthesis, (2) powder metrology, (3) cell prototyping, and (4) cell testing.

Synthesis is the process of forming a cathode powder. As shown in FIG. 4, the synthesis includes mixing precursors, which relates to the stoichiometry of each component element in the final cathode material. The synthesis also includes milling under wet or dry conditions. The synthesis also includes calcination under various temperatures and times. The synthesis further includes surface treatment, which also relates to the material chemistry.

The precursor materials (e.g., lithium salts, phosphates, silica) may then undergo chemical reactions in wet labs to synthesize a powder (e.g., LMX). One method for synthesizing the powder includes solid state synthesis. Solid state synthesis provides a continuous process that can be easily scaled for increased production. For solid state synthesis, the precursor materials do not react during the milling stage. Thus, the powder needs to be intermixed after milling.

The result of the milling process is a slurry in which the precursors may be milled down to a small size (e.g., sub-micron). Several different mills can be used to mill down the powder into a slurry. For example, a horizontal disc mill can be used to mill down the powder into sub-micron sizes. As another example, a planetary ball mill can be used to mill down the powder into a slurry. In some situations, a planetary ball mill may be preferable because the planetary ball mill can be configured to process multiple different compositions or powders in separate jars. In other words, the planetary ball mill may improve throughput by milling multiple different compositions simultaneously. One drawback of the planetary ball mill is that the planetary ball mill may need additional monitoring for temperature and gas, due to generation of undesired gas during milling.

In some situations, water may be used as a milling solvent. In other situations, alcohol or other milling solvents may be used when materials may not be compatible with water.

Other methods of synthesis (e.g., hydrothermal synthesis, solvothermal synthesis, microwave hydrothermal synthesis, etc.) can be complementary to solid state synthesis. These different methods of synthesis can reduce the need for milling due to dissolution of the materials in a solvent during the synthesis process. For example, hydrothermal synthesis can provide a more homogeneous powder. In hydrothermal synthesis, precursor materials are dissolved in a solvent (e.g., water or alcohol, etc.) to form a solution which is placed in an autoclave. The chamber is then sealed, heated to a high temperature (e.g., 200° C.), and pressurized at a high pressure (e.g., 300 Psi). Consequently, the reaction of the precursor materials take place in the solution under high heat and pressure inside a small chamber. After the reaction (e.g., after 24 hours), small crystals or small particles of a powder (e.g., LMX) remain. Hydrothermal synthesis is a slow batch process and is more difficult to scale. For example, typical hydrothermal synthesis can take up to a day to heat the materials and complete synthesis.

As another example, microwave hydrothermal and/or microwave solvothermal synthesis can utilize a microwave to quickly heat up the materials and complete the synthesis (e.g., 20 minutes). Microwave-assisted synthesis creates small batch sizes and is difficult to scale for increased production or throughput.

In some instances, these methods can include “one-pot” synthesis. One-pot synthesis can provide a convenient method of synthesis, in which all the raw materials are combined into one pot, in which the reaction occurs. Thus, the “one-pot” synthesis can provide a simplified process without additional precursor reactions, mixing, and other steps. One drawback for one-pot synthesis techniques is that these techniques are more difficult to control because it is possible that undesired reactions may occur without proper control or precautions.

For wet milling, after the powder is milled into a slurry, the slurry is dried, for example, by spray-drying. In some situations, the drying method may result in different characteristics of the resulting powder. For example, varying the nozzle, pressure, temperature, production chamber, etc. may result in different properties for the powder, such as shape, sphere sizes, etc. In some instances, nitrogen gas may be used to spray materials that may be sensitive to moisture. Another method for drying the materials utilizes a vacuum oven and/or a microwave oven.

After drying the cathode powder, the cathode powder is calcined by heating to an elevated temperature to remove volatile substances. Box furnaces and/or tube furnaces can be used to calcine the cathode powders. Calcination can include various configurable parameters, including temperatures, durations, layers of materials, stack heights, gases used in the furnaces, heating profiles, pressures, etc.

In some instances, the cathode powder may be treated to improve electrical conductivity. Carbon coating is a commonly employed technique for improving the conductivity of cathode active materials in lithium-ion batteries. Carbon coating can improve the electrical conductivity of the cathode active materials without changing other intrinsic properties. Uniform coating of carbon on cathode active materials or compounds helps avoid charge congregation and undesirable chemical reactions. The carbon coatings on cathode active materials or compounds (e.g., LMX), may affect the cycling performance of battery cells produced from the carbon coated cathode powders.

The powder metrology includes performing material characterizations and analyses of the resulting synthesized powder to determine if a cathode powder is suitable for the next step, (e.g., cell prototyping or building a battery cell using the cathode powder). The material characterizations and analyses of the cathode powder are performed to determine one or more characteristics and/or properties of the cathode powder, such as phase purity, crystallinity, particle size, the surface area of a cathode particle, and tap density, among others. In some embodiments, the powder metrology can be performed automatically and the results of the powder metrology can be fed back into a machine learning model used to identify the precursor materials and process parameters for making the powder.

The phase purity, crystallinity, particle size, and surface area of the cathode particle can be determined by material analytical processes (e.g., facilitated by various analytical equipment), including X-ray diffraction analyses (XRD), scanning electron microscopy (SEM), energy-dispersive X-ray spectroscopy (EDS), among others.

For example, tap density is one material property of interest. Tap density considers pores and voids between particles, which are not based on a loose powder bed but a bed after a defined number of tapping steps. The tap density of a cathode powder is determined after the defined tapping steps of the powder bed. The tap density is different from the bulk density of a powder, which considers the pores and voids of a loose powder bed. The bulk density can be determined if a powder is loosely poured into a measuring cylinder.

As further illustrated in FIG. 4, workflow 400 also includes cell prototyping, such as building a battery cell. Specifically, cell prototyping includes electrode preparation, cell assembly, and formation of a battery cell, such as a coin cell. After a cell prototype is formed, the cell can be tested (i.e., cell testing) to determine if the battery cell meets the target cell properties of the battery cell. Some target cell properties include internal resistance, voltage, capacity, and cycle life, among others.

For example, one target cell property is the capacity of a battery or battery cell, which is a measure of the charge stored by the battery. The capacity represents the maximum amount of charge that can be extracted from the battery under certain specified conditions. The battery has a discharge current in the amperes that can be delivered over time. The capacity of the battery is given in ampere-hours (Ah).

### vii. XRD Results

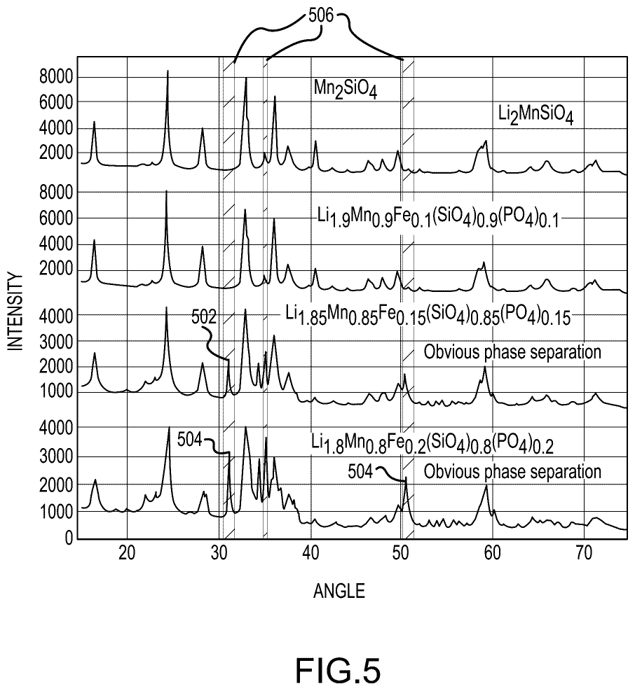

X-ray diffraction analyses (XRD) is an analytical technique used in materials sciences to determine some properties of a material, such as the crystal structure, purity level, and other physical properties. XRD is based on the constructive interference of monochromatic X-rays and a crystalline sample. X-rays are shorter wavelength electromagnetic radiations that can be produced when high-speed electrons collide with a metal target. In XRD, the generated X-rays are collimated (i.e., made parallel) and directed to a material sample, where the interaction of the incident rays with the sample produces a diffracted ray, which is then detected, processed, and counted. The intensity of the diffracted rays is plotted versus angle to display a diffraction pattern, such as those shown in FIGS. 5-10. A vertical axis represents the intensity of the peaks of the diffraction pattern in counts. A horizontal axis represents the angle (two theta) of the peaks of the diffraction pattern.

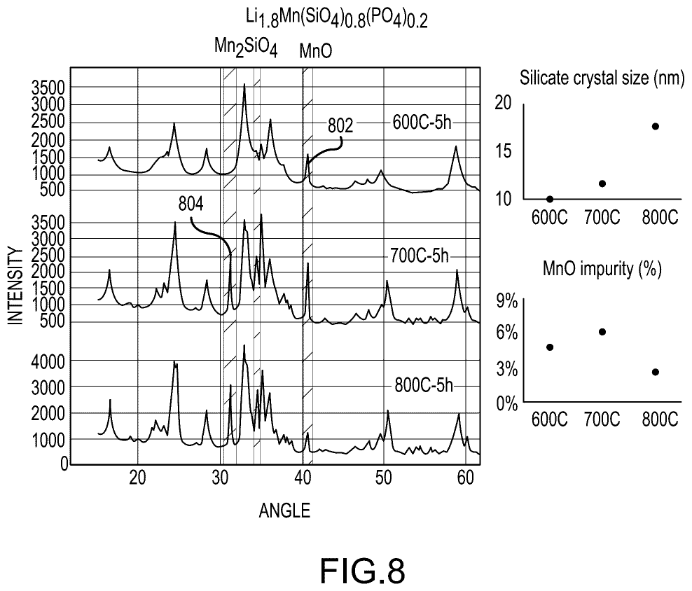

FIG. 5-10 illustrate results from XRD analysis for coin cells with various cathode compounds in Formulas (III), (IV), and (V) and the baseline compound Li₂MnSO₄. The presence of impurities and the amounts of impurities may vary with the formulation of compounds, such as illustrated in FIGS. 5-7. The presence of impurities and the amounts of impurities may also vary with the calcination temperatures, such illustrated in FIGS. 8-10. XRD analyses of the compounds demonstrate that some compounds can be synthesized to be single phase with a minimal level of impurities.

FIG. 5 illustrates XRD results of Li₂₋ₓM(SiO₄)₁₋ₓ(PO₄)ₓ compounds with x=0, 0.1, 0.15, and 0.2 and M=Mn and Fe. As shown in FIG. 5, when x=0 or 0.1 for Li₂₋ₓM(SiO₄)₁₋ₓ(PO₄)ₓ in Formula (III), XRD results indicate the compounds Li₂MnSO₄ and Li_{1.9}Mn_{0.9}Fe_{0.1}(SiO₄)_{0.9}(PO₄)_{0.1} have a single phase, without forming a significant amount of impurities during synthesis (e.g., less than 10 wt % impurities). However, when x increases to 0.15, the diffraction pattern demonstrates a phase separation for Li_{1.85}Mn_{0.95}Fe_{0.15}(SiO₄)_{0.85}(PO₄)_{0.15}, with small peaks 502 (e.g., the impurity content is more than 20 wt %) in grey regions 506, which correspond to presence of an impurity, Mn₂SiO₄. When x increases to 0.2, a phase separation was observed for Li_{1.8}Mn_{0.8}Fe_{0.2}(SiO₄)_{0.8}(PO₄)_{0.2}, with larger peaks 504, in grey regions 506 (e.g., the impurity content is more than 20 wt %). The large peaks 504 appearing in the diffraction pattern indicate more phase separation and more impurities (e.g., Mn₂SiO₄) than peaks 502. Thus, the phase impurity increases with x in Li₂₋ₓM(SiO₄)₁₋ₓ(PO₄)ₓ once x is >0.15.

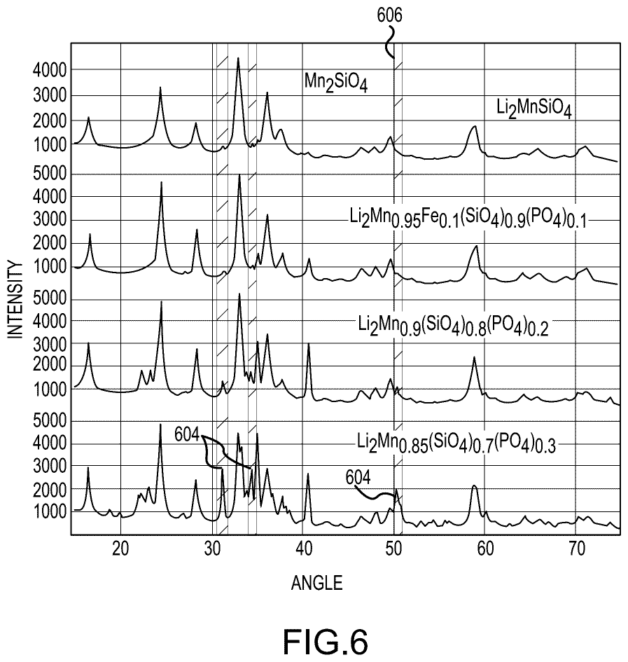

FIG. 6 illustrates XRD results of Li₂M_{1-0.5x}(SiO₄)₁₋ₓ(PO₄)ₓ compounds with x=0, 0.1, 0.2, and 0.3 according to some aspects of the disclosed technology. As shown in FIG. 6, when x=0.1, 0.2, and 0.3 and M=Mn for Li₂M_{1-0.5x}(SiO₄)₁₋ₓ(PO₄)ₓ in Formula (IV), XRD results indicate the compound Li₂Mn_{0.95}(SiO₄)_{0.9}(PO₄)_{0.1} has a single phase, without forming a significant amount of impurity during synthesis (e.g., impurity amount is less than 10 wt %). Also, when x=0.2, the compound Li₂Mn_{0.9}(SiO₄)_{0.8}(PO₄)_{0.2} still does not form a significant amount of impurity during synthesis (e.g., impurity amount is less than 10 wt %). However, when x increases to 0.3, a phase separation is clearly observed in Li₂Mn_{0.85}(SiO₄)_{0.7}(PO₄)_{0.3}, as indicated by large peaks 604 in grey region 606. The large peaks 604 correspond to a substantial amount of Mn₂SiO₄ appearing in the diffraction pattern. Thus, the phase purity exists in Li₂M_{1-0.5x}(SiO₄)₁₋ₓ(PO₄)ₓ when x is no more than 0.3.

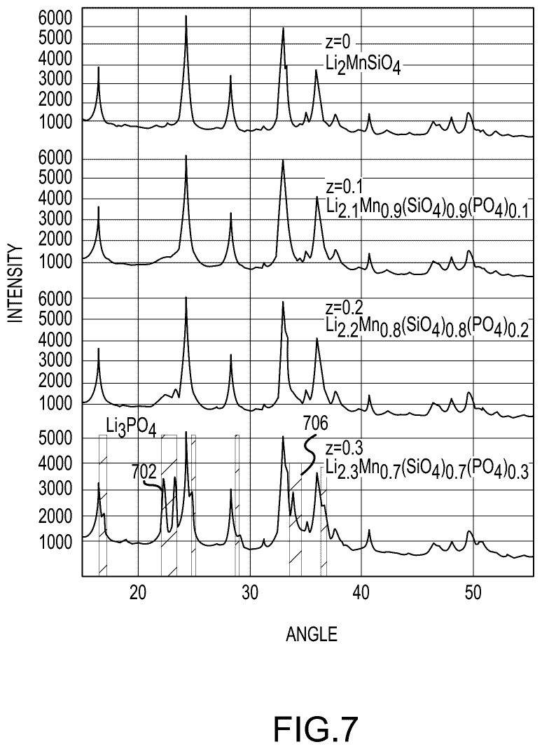

FIG. 7 illustrates XRD results of Li₂₊ₓM₁₊ₓ(SiO₄)₁₋ₓ(PO₄)ₓ compounds with x=0, 0.1, 0.2, and 0.3 according to some aspects of the disclosed technology. As shown in FIG. 7, when x=0, 0.1 or 0.2 and M=Mn for Li₂₊ₓM₁₋ₓ(SiO₄)₁₋ₓ(PO₄)ₓ in Formula (V), XRD results indicate the compounds Li₂MnSiO₄, Li_{2.1}Mn_{0.9}(SiO₄)_{0.9}(PO₄)_{0.1}, Li_{2.2}Mn_{0.8}(SiO₄)_{0.8}(PO₄)_{0.2} are substantially a single phase, without significant amount of impurity showing in the diffraction pattern. However, when x=0.3 and M=Mn, the impurity Li₃PO₄ is present with its characteristic peaks 702 in grey region 706 of the compound Li_{2.3}Mn_{0.7}(SiO₄)_{0.7}(PO₄)_{0.3}, and the amount of impurity Li₃PO₄ is estimated to be greater than 20 wt %. Thus, the compound has phase separation or impurity higher than 20 wt %. Similarly, when x=0.25, the Li₃PO₄ impurity is present in notable quantities.

Compared to the compound Li₂MSiO₄, the reference compound Li₂₊ₓM₁₋ₓ(SiO₄)₁₋ₓ(PO₄)ₓ has no site-vacancies or cation-vacancies and are fully occupied since the sum of cations (Li+M) is 3, while for other the two compounds Li_{2-z}M(SiO₄)_{1-z}(PO₄)_{z} and Li₂M_{1-0.5x}(SiO₄)₁₋ₓ(PO₄)ₓ, there are some site-vacancies since the cation sum is less than 3. As will be discussed in further detail below, the site-vacancies can impact the cycling performance of the cathode materials.

Calcination temperature may also impact the phase purity of different compounds or compositions during synthesis. The effect of the calcination temperature is different for the three compounds in Formulas (I), (II), and (III), which result in different phase purity profiles. As an example, PO₄ is assumed to be 0.2 and M is assumed to be Mn to illustrate the temperature impact for various different compounds using different ratios of Li and M.

FIG. 8 shows the XRD results of Li₂₋ₓM(SiO₄)₁₋ₓ(PO₄)ₓ where x=0.2 and M=Mn, which is Li_{1.8}Mn(SiO₄)₁₋ₓ(PO₄)_{0.2} calcined at three different temperatures, 600° C., 700° C., and 800° C. according to some aspects of the disclosed technology. Presence of the two main impurities MnO and Mn₂SiO₄ may be present during synthesis of the compound based on the calcination temperature. The peaks 804 corresponding to Mn₂SiO₄ are clearly present when the calcination temperature increases to 700° C. or 800° C., indicating a considerable amount of Mn₂SiO₄ appears (e.g., greater than 20 wt %). However, when the compound is calcined at 600° C., there is no detectable Mn₂SiO₄ in the XRD results. Accordingly, the XRD results indicate that Li_{1.8}Mn(SiO₄)_{0.8}(PO₄)_{0.2} is sensitive to calcination temperature profiles, such that a significant amount of impurity Mn₂SiO₄ can emerge when Li_{1.8}Mn(SiO₄)_{0.8}(PO₄)_{0.2} is calcined at higher temperatures.

On the other hand, the peak 802 for a common impurity in Mn-based silicate materials, MnO, is present in less than 10 wt % when calcined at any of these temperatures. The amount of MnO is the lowest when the calcination temperature is 800° C.

As discussed above, a high calcination temperature is not preferred in the above example because significant Mn₂SiO₄ impurity would appear. Meanwhile, the crystal size of silicate is a function of temperature. The crystal size increases with the temperature, which results in relatively lower surface area. This trend applies to the other examples discussed below.

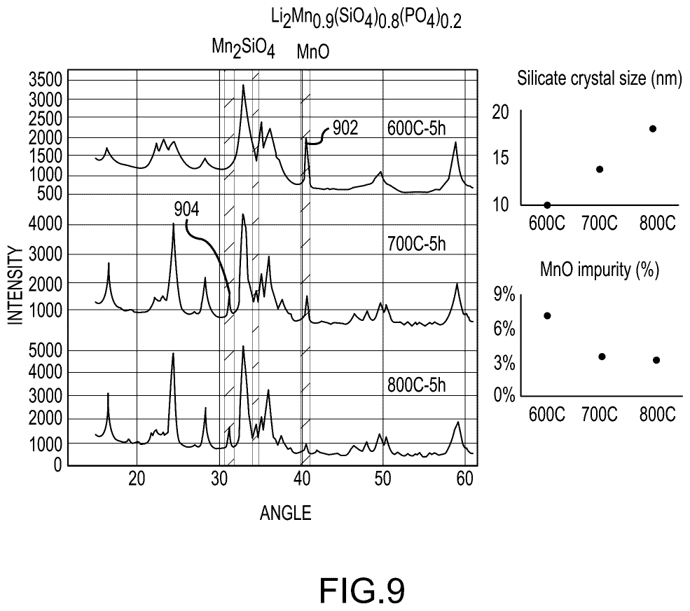

FIG. 9 shows the XRD results of Li₂M_{1-0.5x}(SiO₄)₁₋ₓ(PO₄)ₓ where x=0.2 and M=Mn, which is Li₂Mn_{0.9}(SiO₄)_{0.8}(PO₄)_{0.2}, calcined at three different temperatures, 600° C., 700° C., and 800° C. according to some aspects of the disclosed technology. Peak 902 corresponding to the MnO impurity is the highest at 600° C., decreases to a smaller peak at 700° C., and is nearly absent at 800° C. The amount of MnO impurity is less than 10 wt. % when calcined at 800° C. The higher the temperature, the smaller amount of MnO impurity in the synthesized materials. In contrast, the peaks 904 corresponding to the Mn₂SiO₄ impurity are absent at 600° C. but are present at 700° C. or 800° C. The peaks 904 become higher at 800° C. than 700° C. For this composition of Li₂Mn_{0.9}(SiO₄)_{0.8}(PO₄)_{0.2}, the Mn₂SiO₄ impurity amount is estimated to be less than 10 wt. %. Thus, the compound Li₂Mn_{0.9}(SiO₄)_{0.8}(PO₄)_{0.2} has a single phase when calcined at any of the three different temperatures.

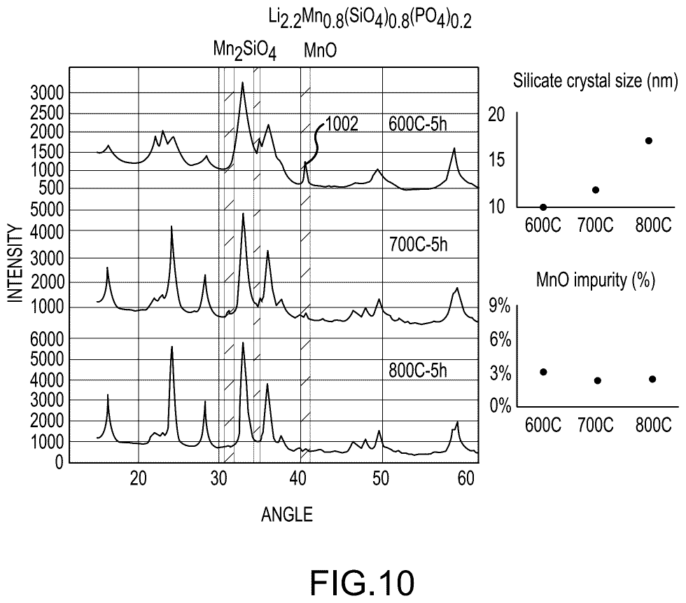

FIG. 10 shows the XRD results of Li₂₊ₓM₁₊ₓ(SiO₄)₁₋ₓ(PO₄)ₓ, when x=0.2 and M=Mn, which is Li_{2.2}Mn_{0.8}(SiO₄)_{0.8}(PO₄)_{0.2}, calcined at three different temperatures, 600° C., 700° C., and 800° C., according to some aspects of the disclosed technology. Peak 1002 corresponding to MnO impurity is reduced with increasing calcination temperature. The MnO impurity is estimated to be less than 10 wt %. For the Mn₂SiO₄ impurity, its amount remains at a very minimal level in Li_{2.2}Mn_{0.8}(SiO₄)_{0.8}(PO₄)_{0.2} regardless of the calcination temperature. At any of 600° C., 700° C., or 800° C., Li_{2.2}Mn_{0.8}(SiO₄)_{0.8}(PO₄)_{0.2} has a single phase without a considerable amount of Mn₂SiO₄.

In summary, the site-vacant materials (Li₂₋ₓM(SiO₄)₁₋ₓ(PO₄)ₓ and Li₂M_{1-0.5x}(SiO₄)₁₋ₓ(PO₄)ₓ) are more sensitive to calcination temperature profiles, and less tolerant to a high calcination temperature. High calcination temperatures may result in phase separation with a significant amount of Mn₂SiO₄ impurity formed during synthesis. For the site-full materials (Li_{2+z}M_{1-z}(SiO₄)_{1-z}(PO₄)_{z}), however, the compound is more tolerant to high calcination temperatures, since the phase purity is maintained regardless of the calcination temperature.

Experiments were performed to synthesize Li_{1.5}Fe_{0.5}Mn_{0.5}(PO₄)_{0.5}(SiO₄)_{0.5}, which is a specific example of the compound Li₁₊ₓM(PO₄)₁₋ₓ(SiO₄)ₓ, where x=0.5 and the metal site is a 50/50 split of Fe/Mn, both of which are in the 2+ oxidation state. Oxidation of Fe from 2+ to 3+ and oxidation of Mn from 2+ to 4+ may allow for the complete extraction of Li from the compound. However, experiments demonstrated that attempts of synthesizing the Li_{1.5}Fe_{0.5}Mn_{0.5}(PO₄)_{0.5}(SiO₄)_{0.5} compound resulted in phase separation during synthesis.

### viii. Cell Tests and Experimental Results

The synthesized powder may be dried in a vacuum oven at an elevated temperature for a period to remove residual moistures in the powder, for example, from 80° C. to 200° C. for about 12 hours or longer. All other cell components or chemicals may also be dried in a vacuum prior to mixing.

A mixer, such as FlackTek Speedmixer or Thinky mixer, may be used for slurry preparation. A polyvinylidene fluoride (PVDF) solution includes 10 wt % PVDF in a N-Methylpyrrolidone (NMP) solvent. Based on the compound, carbon black may be added into the PVDF solution in a mixing cup and then mixed by the mixer. The mixing process involves multiple steps with different mixing speeds and times to ensure a homogeneous dispersion of carbon black in the PVDF solution. Then, cathode active material (CAM) powder may be added to the mixing cup, along with additional NMP solvent to achieve a desired solid content. Additional mixing may take place under another set of mixing speeds and times. Additional NMP solvent may be added and the mixing may be repeated to ensure a good slurry. A small amount of slurry sample may be taken for Hegman gauge measurements and viscosity measurements for the purpose of quality control. The mixer can mix multiple mixing cups simultaneously, and therefore the above steps can be done for multiple different CAM powders simultaneously.

Once the slurry is made, it may be taken to a doctor blade coater. A carbon coated aluminum sheet may be vacuum mounted onto a coater chuck as the substrate. The coater chuck may be heated to 60° C. The gap of the doctor blade coater may be adjusted between about 100 μm and about 400 μm to achieve the desired coating thickness and loading weight. The slurry may then be casted onto the substrate to form a coated substrate, which may be transferred into an oven with forced air. The oven may be heated to 80° C. to dry the coated substrate for at least 4 hours (hrs) to form an electrode. After drying, the thickness and loading weight of the electrode can be measured to calculate the electrode density. The electrode may then be calendared to achieve the desired thickness and density.

The particles can be coated with a carbon coating. One way of forming the carbon coating is to put a soluble sugar (e.g., glucose) in the slurry, which is water-based. After spray drying, the sugar is present in the spray dried powder. During calcination, the sugar decomposes and forms a carbon coating around each particle.

A Hohsen puncher may be used to punch out cathode disks (e.g., about 13.8 mm in diameter) from the electrode for coin cells. Each cathode disk can be weighed to determine the amount of active material and therefore determine the theoretical capacity for each coin cell. These cathode disks may then be dried under 80° C. for 12 hrs or longer in a vacuum chamber attached to a glovebox. After drying, the cathode disks may be transferred into an Ar-filled glovebox without exposure to atmosphere. In the glovebox, the cathode disks can be made into coin cells with polypropylene (PP) or polyethylene (PE) separator, Li metal as anode, and various electrolytes of interest. Various electrolytes may be used to evaluate and understand material degradation mechanisms.

Cathode disks are formed from the synthesized powder as described above. The density of the cathode disk is dependent on the particle size of the powder.

Porosity is a measure of the void spaces in a material. The porosity of the cathode may affect the performance of an electrochemical cell.

For example, cathode disks can be formed starting from powders including Li_{1.9}Mn(SiO₄)_{0.9}(PO₄)_{0.1}, Li_{2.1}Mn_{0.9}(SiO₄)_{0.9}(PO₄)_{0.1}, Li₂Mn_{0.9}(SiO₄)_{0.8}(PO₄)_{0.2}, Li_{2.2}Mn_{0.8}(SiO₄)_{0.8}(PO₄)_{0.2} cathode compounds, and/or the baseline compound, Li₂MnSiO₄.

The cathode disks are assembled into button or coin cell batteries with an anode disk, and an electrolyte. As such, coin cells can be made with Li_{1.9}Mn(SiO₄)_{0.9}(PO₄)_{0.1}, Li_{2.1}Mn_{0.9}(SiO₄)_{0.9}(PO₄)_{0.1}, Li₂Mn_{0.9}(SiO₄)_{0.8}(PO₄)_{0.2}, Li_{2.2}Mn_{0.8}(SiO₄)_{0.8}(PO₄)_{0.2}, and/or Li₂MnSiO₄ cathode disks.

The coin cells are evaluated to determine various characteristics of the cathode material, including capacity, average voltage, volumetric energy density, and discharge energy retention. Cell experiments can include cycle tests performed on the coin cells. Galvanostatic charge/discharge cycling of the coin cells can be conducted. For example, the Galvanostatic charge/discharge cycling of the coin cells can be conducted with operation voltage ranging from 2.0 V to 4.3 V at a rate of C/10 at 45° C.

The coin cells may be loaded into temperature-controlled chambers that may be connected to battery testers (e.g., fabricated by Neware or Arbin) and tested under customized testing protocols. The testing temperature may vary from about 10° C. to about 45° C. Various testing protocols can be designed to evaluate performance of coin cells, including varying testing currents (e.g., from C/100 to 1C), varying voltage ranges (e.g., between about 1.5 V to about 5 V), varying number of cycles (from 1 cycle to 50 cycles), as well as various combinations of all above parameters.

For the tests in this disclosure, the voltage range was 2 V to 4.3 V with a temperature of either 25° C. or 45° C. The current rate was 16.6 mA/g of active material. On charging, a constant voltage was held until the current dropped to below 3.32 mA/g of active material. Note that for all electrochemical data presented here, the shaded band around the data points represents the 95% confidence interval based on the data collected for that sample.

An electrochemical tester provides a user with a variety of options in testing of batteries. Multiple channels can be plugged into the electrochemical tester to allow for multiple batteries to be tested simultaneously. These tests allow the user to fully understand the effectiveness of the electrochemical cell being tested by measuring parameters of the batteries, such as voltage, current, impedance, and capacity, among others. The tester can be attached to a computer to obtain digital testing values.

The following examples are for illustration purposes only. It will be apparent to those skilled in the art that many modifications, both to materials and methods, may be practiced without departing from the scope of the disclosure.

Experimental electrochemical data of coin cells made from the cathode material of Li_{1.9}Mn(SiO₄)_{0.9}(PO₄)_{0.1} have demonstrated better cycling performance than the baseline compound of Li₂MnSiO₄.

### Example 1

Experiments were conducted on coin cells formed from cathode materials where the PO₄ content is fixed at 0.1 to compare the electrochemical performance of the composition Li_{1.9}Mn(SiO₄)_{0.9}(PO₄)_{0.1} with the electrochemical performance of a reference compound Li_{2.1}Mn_{0.9}(SiO₄)_{0.9}(PO₄)_{0.1}. The coin cells are cycled at the voltage range between 2.0 V and 4.3 V at an elevated temperature of 45° C.

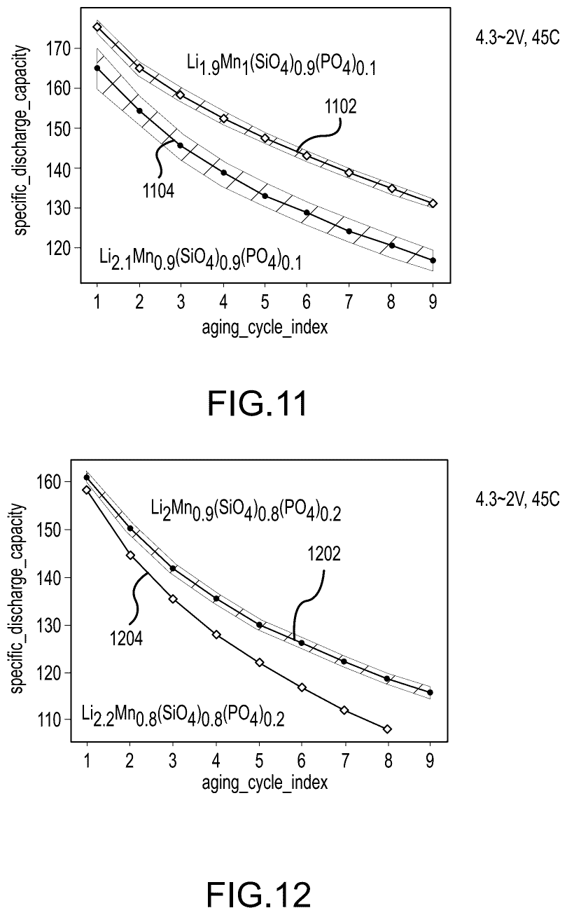

FIG. 11 shows comparisons of specific discharge capacity versus aging cycles for the Li_{1.9}Mn(SiO₄)_{0.9}(PO₄)_{0.1} compound and the Li_{2.1}Mn_{0.9}(SiO₄)_{0.9}(PO₄)_{0.1} compound at 45° C. Curve 1102 represents specific discharge capacity versus aging cycles for the Li_{1.9}Mn(SiO₄)_{0.9}(PO₄)_{0.1} compound at 45° C., and curve 1104 represents specific discharge capacity versus aging cycles for the Li_{2.1}Mn_{0.9}(SiO₄)_{0.9}(PO₄)_{0.1} compound at 45° C. As further shown in FIG. 11, the Li_{1.9}Mn(SiO₄)_{0.9}(PO₄)_{0.1} compound demonstrates better electrochemical performance than Li_{2.1}Mn_{0.9}(SiO₄)_{0.9}(PO₄)_{0.1} in terms of higher capacity and higher capacity retention over cycling. This indicates that structures having site-vacancies (i.e., Li+Mn is less than 3), such as the Li_{1.9}Mn(SiO₄)_{0.9}(PO₄)_{0.1} compound, help improve electrochemical performance over structures having fully occupied sites (i.e., Li+Mn=3), such as the Li_{2.1}Mn_{0.9}(SiO₄)_{0.9}(PO₄)_{0.1} compound.

Experiments were also conducted on coin cells formed from cathode materials where the PO₄ content are fixed at 0.2. The compound Li₂Mn_{0.9}(SiO₄)_{0.8}(PO₄)_{0.2}, which has site-vacancies, outperforms the Li_{2.2}Mn_{0.8}(SiO₄)_{0.8}(PO₄)_{0.2} compound, which has fully occupied sites. These findings are consistent with the trend shown when the PO₄ content is fixed at 0.1.

FIG. 12 shows comparisons of specific discharge capacity versus aging cycles for the Li₂Mn_{0.9}(SiO₄)_{0.8}(PO₄)_{0.2} compound and the Li_{2.2}Mn_{0.8}(SiO₄)_{0.8}(PO₄)_{0.2} compound at 45° C. Curve 1202 represents specific discharge capacity versus aging cycles for the Li₂Mn_{0.9}(SiO₄)_{0.8}(PO₄)_{0.2} compound at 45° C., and curve 1204 represents specific discharge capacity versus aging cycles for the Li_{2.2}Mn_{0.8}(SiO₄)_{0.8}(PO₄)_{0.2} at 45° C. The coin cells were cycled between 2 V and 4.3 V at 45° C. The results also indicate that compounds having a structure with site-vacancies (Li+Mn is less than 3) benefits the structural stability and results in better improved cycling performance.

### Example 2

Coin cells including the cathode compounds when x=0, 0.1, and 0.2 in Formula (III), (IV), and (V) are cycle tested to compare their electrochemical performance. When x=0, the compound is silicate sample Li₂MnSiO₄, which is considered as a baseline. There are two testing environments, one at room temperature 25° C. and another at an elevated temperature 45° C., which are discussed separately.

A. Results from 25° C. Cycling Tests

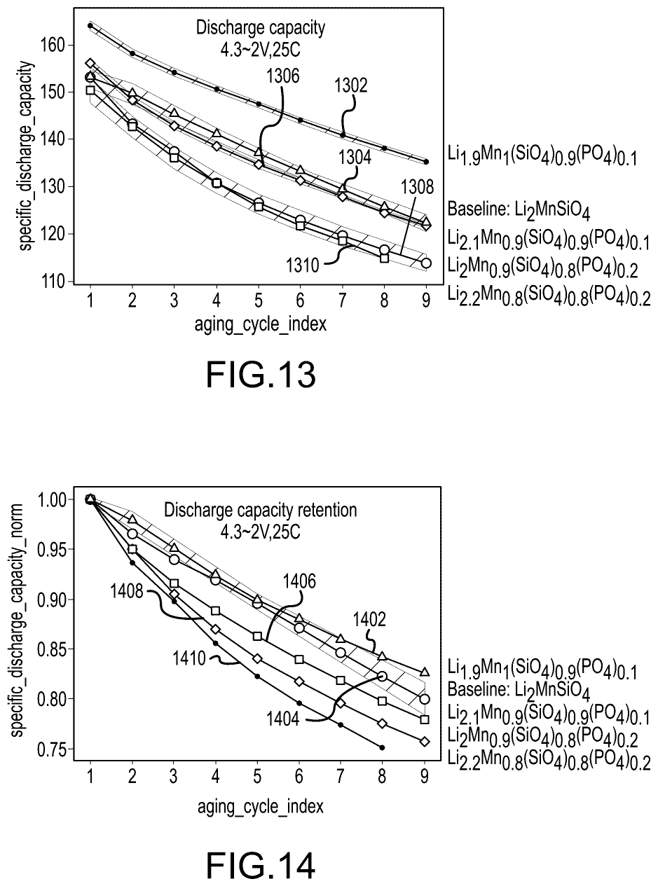

FIG. 13 shows the discharge capacity versus number of cycles for coin cells with various cathode compounds including baseline compound Li₂MnSiO₄ and compound Li_{1.9}Mn (SiO₄)_{0.9}(PO₄)_{0.1} according to some aspects of the disclosed technology. Curve 1302 represents the cell containing the compound Li_{1.9}Mn(SiO₄)_{0.9}(PO₄)_{0.1}. Curve 1304 represents the cell containing the baseline compound, Li₂MnSiO₄. Curve 1306 represents the cell containing the compound Li_{2.1}Mn_{0.9}(SiO₄)_{0.9}(PO₄)_{0.1}. Curve 1308 represents the cell containing the compound Li₂Mn_{0.9}(SiO₄)_{0.8}(PO₄)_{0.2}. Curve 1310 represents the cell containing the compound Li_{2.2}Mn_{0.8}(SiO₄)_{0.8}(PO₄)_{0.2}.

As shown in FIG. 13, it is clear that when x=0.2, the cells including Li₂Mn_{0.9}(SiO₄)_{0.8}(PO₄)_{0.2} and Li_{2.2}Mn_{0.8}(SiO₄)_{0.8}(PO₄)_{0.2} show inferior cycling performance, ending up with lower discharge capacity after cycling, e.g., 9 cycles. However, when x=0.1, the cycling performance of the cell containing the compound Li_{1.9}Mn(SiO₄)_{0.9}(PO₄)_{0.1} with site-vacancies has improved performance compared to that of the cell including the baseline compound Li₂MnSiO₄. The cell containing the compound Li_{1.9}Mn(SiO₄)_{0.9}(PO₄)_{0.1} shows the best performance among the five compounds. In contrast, when x=0.1, the cell containing the compound Li_{2.1}Mn_{0.9}(SiO₄)_{0.9}(PO₄)_{0.1}, which has fully occupied sites, has slightly better performance than the cell containing the compound Li_{2.2}Mn_{0.8}(SiO₄)_{0.8}(PO₄)_{0.2}, which also has fully occupied sites after cycling (e.g., 9 cycles), but worse cycling performance than the cell containing the compound Li_{1.9}Mn(SiO₄)_{0.9}(PO₄)_{0.1}, which has site-vacancies, after cycling (e.g., 9 cycles).

FIG. 14 shows discharge capacity retention versus the number of cycles at 25° C. for coin cells with various cathode compounds including baseline compound Li₂MnSiO₄ and compound Li_{1.9}Mn(SiO₄)_{0.9}(PO₄)_{0.1} according to some aspects of the disclosed technology. The discharge capacity after the number of cycles is normalized against the discharge capacity at the first cycle. Curve 1402 represents the cell containing the compound Li_{1.9}Mn(SiO₄)_{0.9}(PO₄)_{0.1}. Curve 1404 represents the cell containing the baseline compound Li₂MnSiO₄. Curve 1406 represents the cell containing the compound Li_{2.1}Mn_{0.9}(SiO₄)_{0.9}(PO₄)_{0.1}. Curve 1408 represents the cell containing the compound Li₂Mn_{0.9}(SiO₄)_{0.8}(PO₄)_{0.2}. Curve 1410 represents the cell containing the compound Li_{2.2}Mn_{0.8}(SiO₄)_{0.8}(PO₄)_{0.2}.

The coin cells of three mixed SiO₄/PO₄ cathode compounds, as represented by curves 1406, 1408, 1410, do not show higher capacity retention than the cell with baseline compound Li₂MnSiO₄, as represented by curve 1404. However, the coin cell with the cathode compound Li_{1.9}Mn(SiO₄)_{0.9}(PO₄)_{0.1}, as represented by curve 1402, demonstrates higher discharge capacity retention than the baseline compound Li₂MnSiO₄ and outperforms the other three mixed SiO₄/PO₄ cathode compounds.

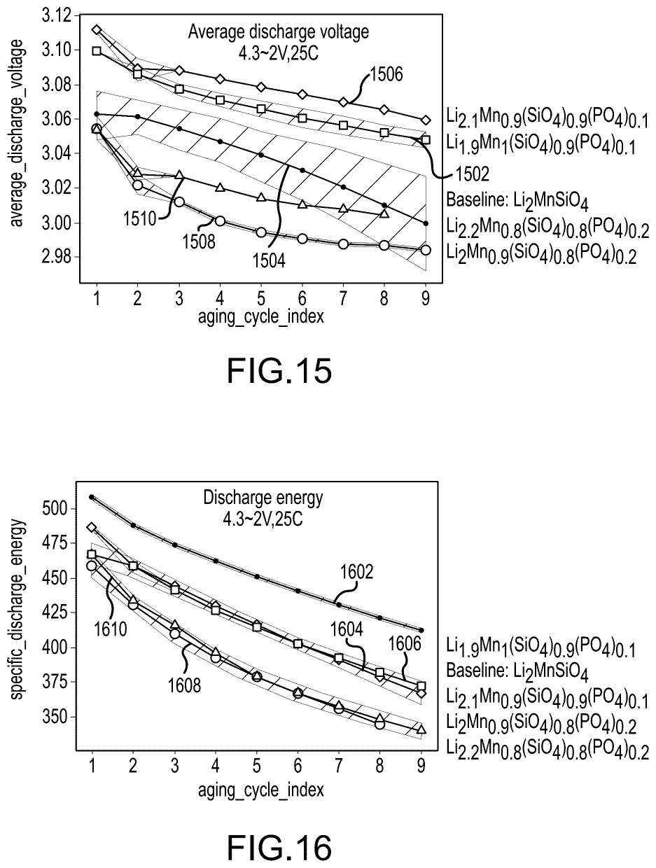

FIG. 15 shows average discharge voltage versus the number of cycles at 25° C. for various coin cells with various compounds including baseline compound Li₂MnSiO₄ and compound Li_{1.9}Mn(SiO₄)_{0.9}(PO₄)_{0.1} according to some aspects of the disclosed technology. Besides capacity, voltage is important for an energy output of a battery cell. Curve 1502 represents the cell containing the compound Li_{1.9}Mn(SiO₄)_{0.9}(PO₄)_{0.1}. Curve 1504 represents the cell including baseline compound, Li₂MnSiO₄. Curve 1506 represents the cell containing the compound Li_{2.1}Mn_{0.9}(SiO₄)_{0.9}(PO₄)_{0.1}. Curve 1508 represents the cell containing the compound Li₂Mn_{0.9}(SiO₄)_{0.8}(PO₄)_{0.2}. Curve 1510 represents the cell containing the compound Li_{2.2}Mn_{0.8}(SiO₄)_{0.8}(PO₄)_{0.2}.

As shown in FIG. 15, both SiO₄/PO₄ compounds when x=0.1, as indicated by curves 1502 and 1506, deliver slightly higher average discharge voltage over cycling than the baseline compound Li₂MnSiO₄, as indicated by curve 1504. However, both SiO₄/PO₄ compounds when x=0.2, as indicated by curves 1508 and 1510, deliver slightly lower average discharge voltage over cycling than the baseline compound Li₂MnSiO₄, as indicated by curve 1504. These results indicate that incorporating some PO₄ in place of SiO₄ may slightly increase the voltage. This may be due to the fact that PO₄ has stronger covalent bonds than SiO₄, which allows PO₄ to help increase the redox voltage of M in the SiO₄/PO₄ compounds through an inductive effect. However, adding too much PO₄ may not benefit the cycling performance.

FIG. 16 shows discharge energy versus the number of cycles at 25° C. for coin cells with various cathode compounds including baseline compound Li₂MnSiO₄ and compound Li_{1.9}Mn(SiO₄)_{0.9}(PO₄)_{0.1} according to some aspects of the disclosed technology. The discharge energy is the product of discharge capacity multiplying average discharge voltage. Curve 1602 represents the cell containing the compound Li_{1.9}Mn(SiO₄)_{0.9}(PO₄)_{0.1}. Curve 1604 represents the cell containing baseline compound Li₂MnSiO₄. Curve 1606 represents the cell containing the compound Li_{2.1}Mn_{0.9}(SiO₄)_{0.9}(PO₄)_{0.1}. Curve 1608 represents the cell containing the compound Li₂Mn_{0.9}(SiO₄)_{0.8}(PO₄)_{0.2}. Curve 1610 represents the cell containing the compound Li_{2.2}Mn_{0.8}(SiO₄)_{0.8}(PO₄)_{0.2}.

Similar to the discharge capacity, Li_{1.9}Mn(SiO₄)_{0.9}(PO₄)_{0.1}, as represented by curve 1602, outperforms the other four compounds, including the baseline compound Li₂MnSiO₄, as represented by curves 1604, 1606, 1608, and 1610, delivering an initial discharge energy up to 508 Wh/kg and the highest discharge energy after cycling (e.g., 9 cycles) among the five compounds.

B. Results from 45° C. Cycling Tests

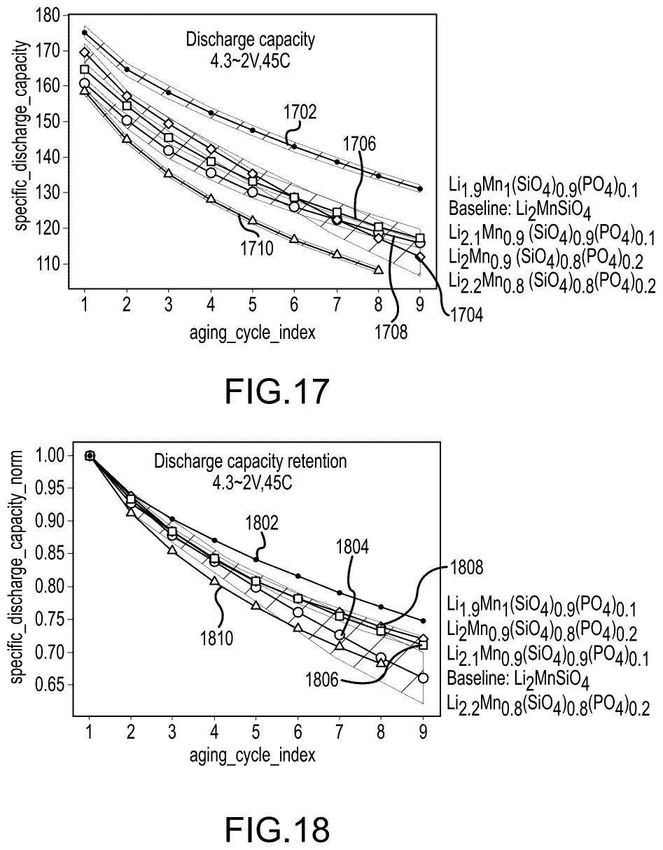

Similar to the cell performance at 25° C., the coin cells cycled at 45° C. also demonstrate better cycling performance from Li_{1.9}Mn(SiO₄)_{0.9}(PO₄)_{0.1} than baseline compound Li₂MnSiO₄, as shown in FIGS. 17-20.

FIG. 17 shows discharge capacity versus the number of cycles at 45° C. for coin cells with various cathode compounds including baseline compound Li₂MnSiO₄ and compound Li_{1.9}Mn(SiO₄)_{0.9}(PO₄)_{0.1} according to some aspects of the disclosed technology. Curves 1702, 1704, 1706, 1708, and 1710 represent the cells containing the compounds L_{1.9}Mn(SiO₄)_{0.9}(PO₄)_{0.1}, baseline compound Li₂MnSiO₄, Li_{2.1}Mn_{0.9}(SiO₄)_{0.9}(PO₄)_{0.1}, Li₂Mn_{0.9}(SiO₄)_{0.8}(PO₄)_{0.2}, and Li_{2.2}Mn_{0.8}(SiO₄)_{0.8}(PO₄)_{0.2}, respectively.

FIG. 18 shows discharge capacity retention versus the number of cycles at 45° C. for coin cells with various cathode compounds including baseline compound Li₂MnSiO₄ and Li_{1.9}Mn(SiO₄)_{0.9}(PO₄)_{0.1} according to some aspects of the disclosed technology. As discussed above, the discharge capacity after the number of cycles is normalized against the discharge capacity at the first cycle to determine the discharge capacity retention. Curves 1802, 1804, 1806, 1808, and 1810 represent the cells containing the compounds Li_{1.9}Mn(SiO₄)_{0.9}(PO₄)_{0.1}, baseline compound Li₂MnSiO₄, Li_{2.1}Mn_{0.9}(SiO₄)_{0.9}(PO₄)_{0.1}, Li₂Mn_{0.9}(SiO₄)_{0.8}(PO₄)_{0.2}, and Li_{2.2}Mn_{0.8}(SiO₄)_{0.8}(PO₄)_{0.2}, respectively. Compounds represented by curves 1802, 1806, and 1808 show better discharge capacity retention than baseline compound, as represented by curve 1804.

The cell containing the compound Li_{1.9}Mn(SiO₄)_{0.9}(PO₄)_{0.1} outperforms the other three cells containing the compounds Li_{2.1}Mn_{0.9}(SiO₄)_{0.9}(PO₄)_{0.1}, Li₂Mn_{0.9}(SiO₄)_{0.8}(PO₄)_{0.2}, and Li_{2.2}Mn_{0.8}(SiO₄)_{0.8}(PO₄)_{0.2}.

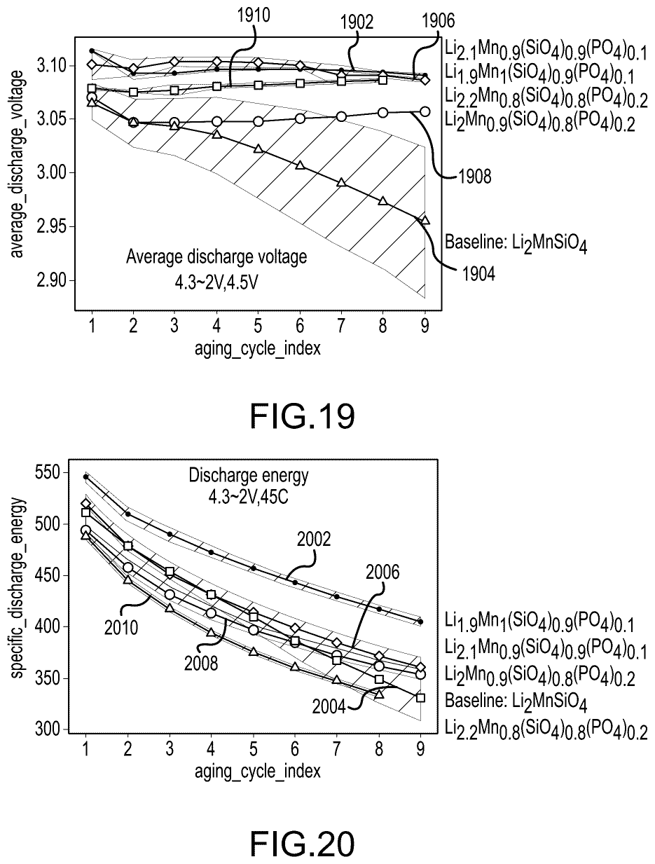

FIG. 19 shows average discharge voltage versus the number of cycles at 45° C. for coin cells with various cathode compounds including baseline compound Li₂MnSiO₄ and compound Li_{1.9}Mn(SiO₄)_{0.9}(PO₄)_{0.1} according to some aspects of the disclosed technology. Curves 1902, 1904, 1906, 1908, and 1910 represent the cells containing the compounds Li_{1.9}Mn(SiO₄)_{0.9}(PO₄)_{0.1}, baseline compound Li₂MnSiO₄, Li_{2.1}Mn_{0.9}(SiO₄)_{0.9}(PO₄)_{0.1}, Li₂Mn_{0.9}(SiO₄)_{0.8}(PO₄)_{0.2}, and Li_{2.2}Mn_{0.8}(SiO₄)_{0.8}(PO₄)_{0.2}, respectively. All four mixed SiO₄/PO₄ compounds when x=0.1 and 0.2, as indicated by curves 1902, 1906, 1908, and 1910, show consistently higher average discharge voltage than the baseline compound Li₂MnSiO₄, as indicated by curve 1904 after cycling, e.g., 4 cycles.

FIG. 20 shows discharge energy versus the number of cycles at 45° C. for coin cells with various cathode compounds including baseline compound Li₂MnSiO₄ and compound Li_{1.9}Mn(SiO₄)_{0.9}(PO₄)_{0.1} according to some aspects of the disclosed technology. Curves 2002, 2004, 2006, 2008, and 2010 represent the cells including Li_{1.9}Mn(SiO₄)_{0.9}(PO₄)_{0.1}, baseline compound Li₂MnSiO₄, Li_{2.1}Mn_{0.9}(SiO₄)_{0.9}(PO₄)_{0.1}, Li₂Mn_{0.9}(SiO₄)_{0.8}(PO₄)_{0.2}, and Li_{2.2}Mn_{0.8}(SiO₄)_{0.8}(PO₄)_{0.2}, respectively. Similar to discharge capacity and discharge capacity retention, as illustrated in FIGS. 18-19, compounds represented by curves 2002, 2006, and 2008 show better discharge energy than baseline compound after cycling, e.g., 9 cycles, as represented by curve 2004. The cell including the Li_{1.9}Mn(SiO₄)_{0.9}(PO₄)_{0.1} cathode compound outperforms the other three cells containing Li_{2.1}Mn_{0.9}(SiO₄)_{0.9}(PO₄)_{0.1}, Li₂Mn_{0.9}(SiO₄)_{0.8}(PO₄)_{0.2}, and Li_{2.2}Mn_{0.8}(SiO₄)_{0.8}(PO₄)_{0.2}.

As shown in FIGS. 13-20, at either room temperature cycling or elevated temperature cycling conditions (e.g., at 45° C.), the electrochemical testing results indicate that Li_{1.9}Mn(SiO₄)_{0.9}(PO₄)_{0.1} delivers both a higher capacity and improved cycling stability when compared to the baseline compound Li₂MnSiO₄. These metrics are also better than those of the other SiO₄/PO₄ compounds, e.g., those of Li₂Mn_{0.9}(SiO₄)_{0.8}(PO₄)_{0.2} and Li_{2.2}Mn_{0.8}(SiO₄)_{0.8}(PO₄)_{0.2}. The results suggest that adding too much PO₄ to replace the SiO₄ may not be beneficial to improve the structural stability.

### IX. Neural Network Architecture and Machine Learning

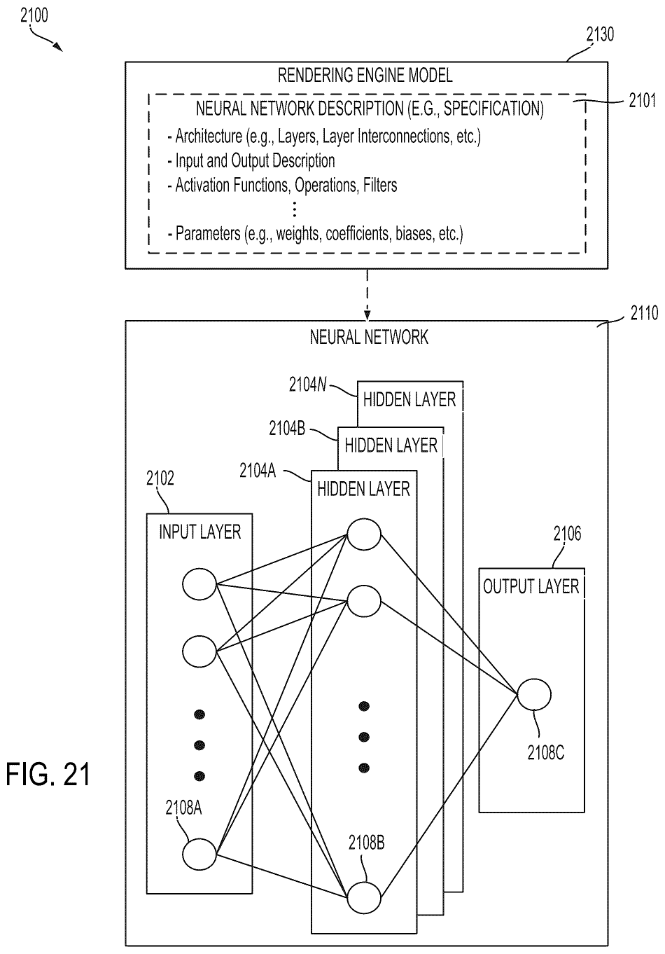

FIG. 21 illustrates an example neural network architecture, in accordance with some aspects of the present technology. Architecture 2100 includes a neural network 2110 defined by an example neural network description 2101 in rendering engine model (neural controller) 330.

The neural network 2110 can represent a neural network implementation of a rendering engine for rendering media data. The neural network description 2101 can include a full specification of the neural network 2110, including the neural network architecture 2100. For example, the neural network description 2101 can include a description or specification of the architecture 2100 of the neural network 2110 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 2110 reflects the architecture 2100 defined in the neural network description 2101. In this example, the neural network 2110 includes an input layer 2102, which includes input data, such as powder information and coin cell electrochemical data. In one illustrative example, the input layer 2102 can include seed data including coin cell electrochemical data.

The neural network 2110 includes hidden layers 2104A through 2104N (collectively “2104” hereinafter). The hidden layers 2104 can include n number of hidden layers, where n is an integer greater than or equal to one. The number of hidden layers can include as many layers as needed for the desired processing outcome and/or rendering intent. The neural network 2110 further includes an output layer 2106 that provides an output (e.g., the variables in the design space to result in coin cells with the coin cell energy density or gravimetric energy density (GED), tap density, or volume energy density (VED), among others) resulting from the processing performed by the hidden layers 2104. In one illustrative example, the output layer 2106 can provide parameters for the variables in the design space that can maximize the coin cell energy density, GED, tap density, or VED.

The neural network 2110 in this example is a multi-layer neural network of interconnected nodes. Each node can represent a piece of information. Information associated with the nodes is shared among the different layers and each layer retains information as information is processed. In some cases, the neural network 2110 can include a feed-forward neural network, in which case there are no feedback connections where outputs of the neural network are fed back into itself. In other cases, the neural network 2110 can include a recurrent neural network, which can have loops that allow information to be carried across nodes while reading in input.

Information can be exchanged between nodes through node-to-node interconnections between the various layers. Nodes of the input layer 2102 can activate a set of nodes in the first hidden layer 2104A. For example, as shown, each of the input nodes of the input layer 2102 is connected to each of the nodes of the first hidden layer 2104A. The nodes of the hidden layer 2104A can transform the information of each input node by applying activation functions to the information. The information derived from the transformation can then be passed to and can activate the nodes of the next hidden layer (e.g., 2104B), which can perform their own designated functions. Example functions include convolutional, up-sampling, data transformation, pooling, and/or any other suitable functions. The output of the hidden layer (e.g., 2104B) can then activate nodes of the next hidden layer (e.g., 2104N), and so on. The output of the last hidden layer can activate one or more nodes of the output layer 2106, at which point output is provided. In some cases, while nodes (e.g., nodes 2108A, 2108B, 2108C) in the neural network 2110 are shown as having multiple output lines, a node has a single output and all lines are shown as being output from a node representing the same output value.

In some cases, each node or interconnection between nodes can have a weight that is a set of parameters derived from training the neural network 2110. Once the neural network 2100 is trained, it can be referred to as a trained neural network, or trained machine learning algorithm which can be used to classify one or more activities. For example, an interconnection between nodes can represent a piece of information learned about the interconnected nodes. The interconnection can have a numeric weight that can be tuned (e.g., based on a training dataset), allowing the neural network 2110 to be adaptive to inputs and able to learn as more data is processed.

The neural network 2110 can be pre-trained to process the features from the data in the input layer 2102 using the different hidden layers 2104 to provide the output through the output layer 2106. In an example in which the neural network 2110 is used to identify an object collision path from a trained object path prediction algorithm, the neural network 2110 can be trained using training data that includes seed data obtained from experiments, such as coin cell electrochemical data, or powder information, where the powder was synthesized from experiments. For instance, training seed data can be input into the neural network 2110, which can be processed by the neural network 2110 to generate outputs that can be used to tune one or more aspects of the neural network 2110, such as weights, biases, etc.

In some cases, the neural network 2110 can adjust the weights of nodes using a training process called backpropagation. Backpropagation can include a forward pass, a loss function, a backward pass, and a weight update. The forward pass, loss function, backward pass, and parameter update are performed for one training iteration. The process can be repeated for a certain number of iterations for each set of training media data until the weights of the layers are accurately tuned. For a first training iteration for the neural network 2110, the output can include values that do not give preference to any particular class due to the weights being randomly selected at initialization. For example, if the output is a vector with probabilities that the object includes the different product(s) and/or different users, the probability value for each of the different products and/or users may be equal or at least very similar (e.g., for ten possible products or users, each class may have a probability value of 0.1). With the initial weights, the neural network 2110 is unable to determine low-level features and thus cannot make an accurate determination of what the classification of the object might be. A loss function can be used to analyze errors in the output. Any suitable loss function definition can be used. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) can be high for the first training dataset (e.g., images) since the actual values will be different than the predicted output. The goal of training is to minimize the amount of loss so that the predicted output comports with a target or ideal output. The neural network 2110 can perform a backward pass by determining which inputs (weights) most contributed to the loss of the neural network 2110 and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=w_i−η dL/dW, where w denotes a weight, wi denotes the initial weight, and f denotes a learning rate. The learning rate can be set to any suitable value, with a high learning rate including larger weight updates and a lower value indicating smaller weight updates.

The neural network 2110 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 2110 can represent any other neural or deep learning network, such as an autoencoder, deep belief nets (DBNs), recurrent neural networks (RNNs), etc.

As understood by those of skill in the art, machine-learning-based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; generative adversarial networks (GANs); support vector machines; image registration methods; applicable rule-based system. Where regression algorithms are used, they may include but are not limited to: a Stochastic Gradient Descent Regressor, and/or a Passive-Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

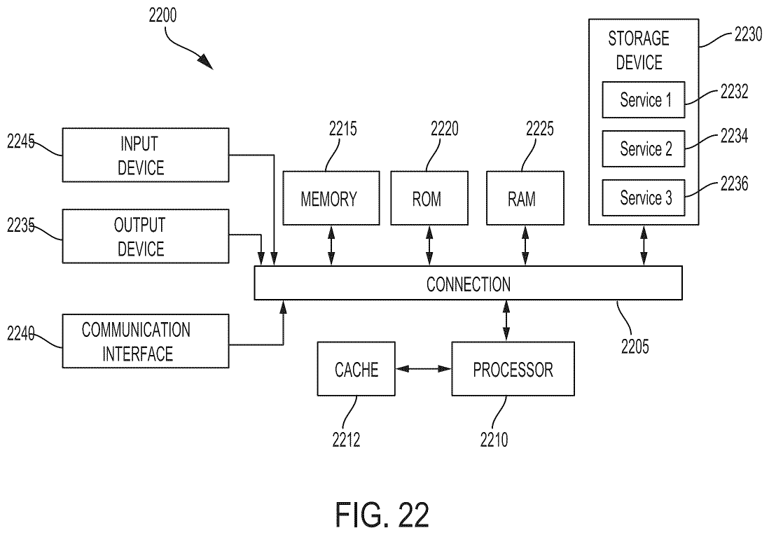

FIG. 22 illustrates an example processor-based system with which some aspects of the subject technology can be implemented. For example, processor-based system 2200 can be any computing device making up, or any component thereof in which the components of the system are in communication with each other using connection 2205. Connection 2205 can be a physical connection via a bus, or a direct connection into processor 2210, such as in a chipset architecture. Connection 2205 can also be a virtual connection, networked connection, or logical connection.

In some embodiments, computing system 2200 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

The example system 2200 includes at least one processing unit (Central Processing Unit (CPU) or processor) 2210 and connection 2205 that couples various system components including system memory 2215, such as Read-Only Memory (ROM) 2220 and Random-Access Memory (RAM) 2225 to processor 2210. Computing system 2200 can include a cache of high-speed memory 2212 connected directly with, close to, or integrated as part of processor 2210.

Processor 2210 can include any general-purpose processor and a hardware service or software service, such as services 2232, 2234, and 2236 stored in storage device 2230, configured to control processor 2210 as well as a special-purpose processor where software instructions are incorporated into the actual processor design. Processor 2210 may essentially be a completely self-contained computing system, containing multiple cores or processors, a bus, memory controller, cache, etc. A multi-core processor may be symmetric or asymmetric.

To enable user interaction, computing system 2200 includes an input device 445, which can represent any number of input mechanisms, such as a microphone for speech, a touch-sensitive screen for gesture or graphical input, keyboard, mouse, motion input, speech, etc. Computing system 2200 can also include output device 2235, which can be one or more of a number of output mechanisms known to those of skill in the art. In some instances, multimodal systems can enable a user to provide multiple types of input/output to communicate with computing system 2200. Computing system 2200 can include communications interface 440, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 440 may also include one or more Global Navigation Satellite System (GNSS) receivers or transceivers that are used to determine the location of the computing system 2200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 2230 can include software services, servers, services, etc., that when the code that defines such software is executed by the processor 2210, it causes the system 2200 to perform a function. In some embodiments, a hardware service that performs a particular function can include the software component stored in a computer-readable medium in connection with the necessary hardware components, such as processor 2210, connection 2205, output device 2235, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments.

Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like.

Embodiments may also be practiced in distributed computing environments where tasks are performed by local and remote processing devices that are linked (either by hardwired links, wireless links, or a combination thereof) through a communications network. In a distributed computing environment, program modules may be located in both local and remote memory storage devices.

### X. Additional XRD Results

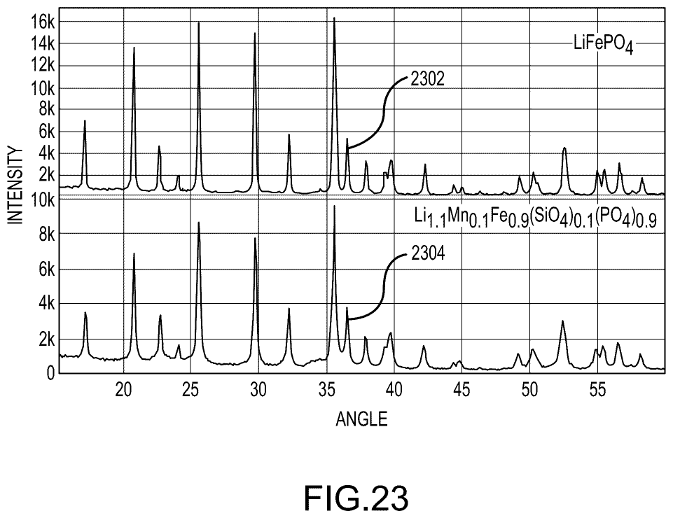

FIG. 23 illustrates XRD results of compounds LiFePO₄ and Li_{1.1}Mn_{0.1}Fe_{0.9}(SiO₄)_{0.1}(PO₄)_{0.9} according to some aspects of the disclosed technology. The LiFePO₄ compound has a high level of phase purity. As shown in FIG. 23, XRD pattern 2304 for the compound Li_{1.1}Mn_{0.1}Fe_{0.9}(SiO₄)_{0.1}(PO₄)_{0.9} contains the same peaks as XRD pattern 2302 for the compound LiFePO₄. Therefore, the XRD results indicate that the compound Li_{1.1}Mn_{0.1}Fe_{0.9}(SiO₄)_{0.1}(PO₄)_{0.9} has minimal impurities, which are under the detection limit of the XRD.

It will be understood that the cathode active materials described herein can be used in conjunction with any battery cells or components thereof known in the art. For example, in addition to wound battery cells, the layers may be stacked and/or used to form other types of battery cell structures, such as bi-cell structures. All such battery cell structures are known in the art.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Aspect 1. A powder comprising a lithium metal polyanion (LMX) compound represented by Formula (I) Li₁₊ₓM(PO₄)₁₋ₓ(SiO₄)ₓ, Formula (I) wherein 0.001<x<0.25 or 0.75<x<1, wherein M is one or more metal cations summing to a stoichiometry of 1.

Aspect 2. The powder of aspect 1, wherein M is one or more selected from a group of elements consisting of Mn, Fe, V, Co, Ni, Mg, Zn, Ca, Na, Al, Cr, or Cu.

Aspect 3. The powder of aspect 1, wherein M is Mn, x=0.9 the compound is represented by Li_{1.9}Mn(SiO₄)_{0.9}(PO₄)_{0.1}.

Aspect 4. The powder of aspect 1, wherein M is Mn and Fe, x=0.9 the compound is represented by Li_{1.9}Mn_{0.9}Fe_{0.1}(SiO₄)_{0.9}(PO₄)_{0.1}.

Aspect 5. The powder of aspect 1, wherein at least one process variable or at least one stoichiometry variable required to produce the compound represented in Formula (I) is provided by a machine learning algorithm.

Aspect 6. A cathode active material comprising the powder of aspect 1.

Aspect 7. A cathode comprising the cathode active material of aspect 6.

Aspect 8. A battery cell comprising a cathode of aspect 7; a separator; and an anode, wherein the battery cell comprises a gravimetric capacity exceeding 170 mAh/g when normalized to the cathode active material mass.

Aspect 9. A method of designing the LMX compound of aspect 1, the method comprising optimizing composition of the LMX compound for the battery cell to achieve the gravimetric capacity exceeding 170 mAh/g when normalized to the cathode active material mass using a machine learning (ML) assisted design combined with an experimental approach.

Aspect 10. The method of aspect 9, the method further comprising: synthesizing the compound to form the powder of claim 1; evaluating the powder and the battery cell of claim 8 for electrochemical performance; using the electrochemical performance and powder information to train a Machine Learning model (ML); fitting a Gaussian process model using energy density of the battery cell as output, subject to constraints of powder level metrics falling within a set of specifications; using an acquisition function to determine N variations to evaluate in a next iteration, that is likely to maximize the energy density; synthesizing the N variations; evaluating the powder and the electrochemical performance of the battery cell; and repeating experiments and training the ML model until a difference in successive iterations falls below a threshold.

Aspect 11. A powder comprising a lithium metal polyanion (LMX) compound represented by Formula (II) LiₐM_{b}(SiO₄)_{1-c}(PO₄)_{c}, Formula (II) wherein a+b<3.0, 1.33≤a≤2.25, 0.75≤b≤1.33, 0.001<c<0.25, wherein M represents one or more metal cations.

Aspect 12. The powder of aspect 11, wherein M is one or more selected from a group of elements consisting of Mn, Fe, V, Co, Ni, Mg, Zn, Ca, Na, Al, Cr, or Cu.

Aspect 13. The powder of aspect 11, wherein M is Mn, a=1.9, b=1, c=0.1, the compound is represented by Li_{1.9}Mn(SiO₄)_{0.9}(PO₄)_{0.1}.

Aspect 14. The powder of aspect 11, wherein M is Mn and Fe, c=0.1, the compound is represented by Li_{1.9}Mn_{0.9}Fe_{0.1}(SiO₄)_{0.9}(PO₄)_{0.1}.

Aspect 15. The powder of aspect 11, wherein at least one process variable or at least one stoichiometry variable required to produce the compound represented in Formula (II) is provided by a machine learning algorithm.

Aspect 16. A cathode active material comprising the powder of aspect 11.

Aspect 17. A cathode comprising the cathode active material of aspect 16.

Aspect 18. A battery cell comprising a cathode of aspect 17; a separator; and an anode, wherein the battery cell comprises a gravimetric capacity exceeding 170 mAh/g when normalized to the cathode active material mass.

Aspect 19. A method of designing the LMX compound of aspect 11, the method comprising optimizing composition of the LMX compound for the battery cell to achieve the gravimetric capacity exceeding 170 mAh/g when normalized to the cathode active material mass using a machine learning (ML) assisted design combined with an experimental approach.

Aspect 20. The method of aspect 19, the method further comprising: synthesizing the compound to form the powder of claim 11; evaluating the powder and the battery cell of claim 18 for electrochemical performance; using the electrochemical performance and powder information to train a Machine Learning model; fitting a Gaussian process model using energy density of the battery cell as output, subject to constraints of powder level metrics falling within a set of specifications; using an acquisition function to determine N variations to evaluate in a next iteration, that is likely to maximize the energy density; synthesizing the N variations; evaluating the powder and the electrochemical performance of the battery cell; and repeating experiments and training the ML model until a difference in successive iterations falls below a threshold.

What is claimed:

1. A powder comprising a lithium metal polyanion (LMX) compound represented by Formula (I)
Li₁₊ₓM(PO₄)₁₋ₓ(SiO₄)ₓ, Formula (I)
wherein 0.001<x<0.25 or 0.75<x<1, wherein M is one or more metal cations summing to a stoichiometry of 1.

2. The powder of claim 1, wherein M is one or more selected from a group of elements consisting of Mn, Fe, V, Co, Ni, Mg, Zn, Ca, Na, Al, Cr, or Cu.

3. The powder of claim 1, wherein M is Mn, x=0.9 the compound is represented by Li_{1.9}Mn(SiO₄)_{0.9}(PO₄)_{0.1}.

4. The powder of claim 1, wherein M is Mn and Fe, x=0.9 the compound is represented by Li_{1.9}Mn_{0.9}Fe_{0.1}(SiO₄)_{0.9}(PO₄)_{0.1}.

5. The powder of claim 1, wherein at least one process variable or at least one stoichiometry variable required to produce the compound represented in Formula (I) is provided by a machine learning algorithm.

6. A cathode active material comprising the powder of claim 1.

7. A cathode comprising the cathode active material of claim 6.

8. A battery cell comprising
a cathode of claim 7;
a separator; and
an anode, wherein the battery cell comprises a gravimetric capacity exceeding 170 mAh/g when normalized to the cathode active material mass.

9. A method of designing the LMX compound of claim 1, the method comprising optimizing composition of the LMX compound for the battery cell to achieve the gravimetric capacity exceeding 170 mAh/g when normalized to the cathode active material mass using a machine learning (ML) assisted design combined with an experimental approach.

10. The method of claim 9, the method further comprising:
synthesizing the compound to form the powder of claim 1;
evaluating the powder and the battery cell of claim 8 for electrochemical performance;
using the electrochemical performance and powder information to train a Machine Learning model (ML);
fitting a Gaussian process model using energy density of the battery cell as output, subject to constraints of powder level metrics falling within a set of specifications;
using an acquisition function to determine N variations to evaluate in a next iteration, that is likely to maximize the energy density;
synthesizing the N variations;
evaluating the powder and the electrochemical performance of the battery cell; and
repeating experiments and training the ML model until a difference in successive iterations falls below a threshold.

11. A powder comprising a lithium metal polyanion (LMX) compound represented by Formula (II)
LiₐM_{b}(SiO₄)_{1-c}(PO₄)_{c}, Formula (II)
wherein a+b<3.0, 1.33≤a≤2.25, 0.75≤b≤1.33, 0.001<c<0.25, wherein M represents one or more metal cations.

12. The powder of claim 11, wherein M is one or more selected from a group of elements consisting of Mn, Fe, V, Co, Ni, Mg, Zn, Ca, Na, Al, Cr, or Cu.

13. The powder of claim 11, wherein M is Mn, a=1.9, b=1, c=0.1, the compound is represented by Li_{1.9}Mn(SiO₄)_{0.9}(PO₄)_{0.1}.

14. The powder of claim 11, wherein M is Mn and Fe, c=0.1, the compound is represented by Li_{1.9}Mn_{0.9}Fe_{0.1}(SiO₄)_{0.9}(PO₄)_{0.1}.

15. The powder of claim 11, wherein at least one process variable or at least one stoichiometry variable required to produce the compound represented in Formula (II) is provided by a machine learning algorithm.

16. A cathode active material comprising the powder of claim 11.

17. A cathode comprising the cathode active material of claim 16.

18. A battery cell comprising
a cathode of claim 17;
a separator; and
an anode, wherein the battery cell comprises a gravimetric capacity exceeding 170 mAh/g when normalized to the cathode active material mass.

19. A method of designing the LMX compound of claim 11, the method comprising optimizing composition of the LMX compound for the battery cell to achieve the gravimetric capacity exceeding 170 mAh/g when normalized to the cathode active material mass using a machine learning (ML) assisted design combined with an experimental approach.

20. The method of claim 19, the method further comprising:
synthesizing the compound to form the powder of claim 11;
evaluating the powder and the battery cell of claim 18 for electrochemical performance;
using the electrochemical performance and powder information to train a Machine Learning model;
fitting a Gaussian process model using energy density of the battery cell as output, subject to constraints of powder level metrics falling within a set of specifications;
using an acquisition function to determine N variations to evaluate in a next iteration, that is likely to maximize the energy density;
synthesizing the N variations;
evaluating the powder and the electrochemical performance of the battery cell; and
repeating experiments and training the ML, model until a difference in successive iterations falls below a threshold.
